(19) United States
(12) Patent Application Publication
(10) Pub. No.: US 2013/0318784 A1
(43) Pub. Date: Dec. 5, 2013

(54) INTERACTIVE TOY ASSEMBLY WORKSHOP AND METHOD FOR CREATING A TOY WITH A DIGITAL PROFILE

(71) Applicant: BUILD-A-BEAR WORKSHOP, INC., St. Louis, MO (US)

(72) Inventor: Brandon Elliott, St. Charles, MO (US)

(73) Assignee: BUILD-A-BEAR WORKSHOP, INC., St. Louis, MO (US)

(21) Appl. No.: 13/828,273

(22) Filed: Mar. 14, 2013

Related U.S. Application Data
(60) Provisional application No. 61/653,945, filed on May 31, 2012.
(60) Provisional application No. 61/684,420, filed on Aug. 17, 2012.
(60) Provisional application No. 61/697,530, filed on Sep. 6, 2012.

(51) Int. Cl. A63H 3/02; G06F 17/30

(52) U.S. Cl. CPC A63H 3/02; G06F 17/30286
USPC 29/805; 707/803

(57) ABSTRACT

Systems and methods for providing an interactive toy assembly workshop and methods for making a toy which utilizes a digital profile so as to be increasingly personalized. The workshop is composed of a variety of stations which are specifically related to various assembly tasks in the process of taking an unfinished plush toy and producing a finished toy design. While some of these stations are geared to more hands on tasks in selecting and actually assembling the toy, others are specifically designed to provide interactive experiences that enhance the personality of the toy, make it unique, and provide for it to be anthropomorphized by the user in a particular way by creating and using a digital profile with the toy.

### CROSS REFERENCE TO RELATED APPLICATION(S)

This application claims the benefit of U.S. Provisional Patent Application Ser. No. 61/653,945 filed May 31, 2012, U.S. Provisional Patent Application Ser. No. 61/684,420 filed Aug. 17, 2012, and U.S. Provisional Patent Application Ser. No. 61/697,530 filed Sep. 6, 2012. The entire disclosure of all the above documents is herein incorporated by reference.

### BACKGROUND

1. Field of the Invention

This disclosure relates to systems and methods for providing for an interactive toy assembly workshop, particularly to a workshop for the assembly of plush toys, that utilizes various interactive stations to provide for a simultaneous physical and digital play experience which personalizes the created toy through use of a digital profile.

2. Description of Related Art

As the world has become more advanced, virtually every aspect of human existence has incorporated new technologies. In many respects, toys, generally objects used for play to train children for future life which are often designed to be versions of objects used by adults, have been around for much of recorded human history. Because toys are often designed to teach intended behavior, toys have changed as the world has changed to allow for children to play with objects that have become commonplace.

Prior to the invention of the telephone, there was no need for toy telephones. Similarly, prior to the invention of the automobile, there were no toy cars or trucks. While the types of toys emulate the environment and era in which children grow, toys also gain increased functionality as technology of the era provides for better and safer ways to incorporate functionalities into toys through the use of devices that are often sophisticated machines more so than playthings.

An early toy telephone may have looked like a telephone, but it generally did not provide for parts that operated like those of a real telephone. However, as technology has improved, toy telephones have become more like the real thing. From mechanical bells and sounds, to recordings of parts of conversations, to modern toys that incorporate moveable buttons which control computer chips so that the telephone can be manipulated like a real telephone, toys have become increasingly “real”.

One major advancement in toys recently is the ability of the toys to operate in interactive environments, specifically digital environments such as the Internet or computer simulated worlds. For example, a physical toy may interact with a computer game where the toy is represented by an avatar, or may provide for the user to manipulate the toy and have that interaction be translated to an on-screen action. Such a toy's digital interaction is through computer components in the toy and a connection to a computer or other general interactive display device such as a television. For example, a plush toy may “speak” when it receives a signal from an interactive device, such as a computer or television, or when the toy's user does something in an environment presented on the screen. The sounds issued will usually be connected to the activity on the display screen and therefore the toy can appear to interact with the screen occurrences.

These interactions are, however, limited in several very important ways. In the first instance, the interactions have traditionally required both the digital machine providing the environment, and the toy, to be digital devices designed to communicate with each other. That is, they both have to have mutual communication protocols and electronic hardware within them. This can be expensive as, effectively, interactive toys must include a sophisticated machine to allow the toy to appear to interact. Further, such interaction can be power demanding, and changing batteries in a toy can be difficult. Still further, the inclusion of such devices can ruin the appearance or feel of toy (e.g., a soft plush toy is no longer soft, but now includes a hard chunk of electronics and batteries within it).

A second major limitation to such digitally interactive toys is that the environment is generally not an interactive play environment. Instead, the environment is a screen simulation of an interactive world. Thus, children are not playing within the environment (e.g., as they would with a toy kitchen) but are directing interaction in a simulated environment (e.g., manipulating an image of a kitchen on the screen). This is a less “natural” interaction and as parents have become increasingly concerned with their children's screen time and the amount of time they spend with virtual play, the desire to provide children with immersive simulated environments, which only exist online or in a computer or television, have decreased. Instead, parents have desired more “hands-on” toys where a user is manipulating the toy directly, instead of manipulating an avatar.

Because of the increase in available computing power, the ability to utilize digital control in all types of devices has become more common. However, while digital devices are commonly incorporated as control panels or as internal components, there have not yet been devices where the control panel becomes a part of an interactive device in a fashion where the control aspect is designed to be camouflaged and which can interact with non-digital devices. That is, devices have not been provided where the digital aspect is somewhat hidden, where the digital aspect is combined to provide sensory stimulation as part of a larger more immersive play environment, and where non-digital toys can interact with the play environment.

This broader type of play environment can allow for play with non-digital toys to be digitally interactive which allows for a much broader universe of toys to be used in the environment, and provides that the cost of each toy is reduced because the inclusion of digital components to provide the interaction is not necessary. Further, the play environment not being totally simulated can be desirable to provide for better development (e.g., of gross motor skills). Effectively, the computer system in the play station goes from simulating an environment, to being a control system or partial simulation within a real environment. This can be a much more immersive and realistic play experience and is often referred to herein as creating an enhanced reality.

In the last 15 years, the manufacturing process of toys has also become additionally personalized through the advent of toy stores where the toy is not just purchased off of a rack, but is, at least partially, manufactured by the user him or herself. One such type of store is the Build-a-Bear Workshop® store where a person can construct a plush toy from various provided components such as a shell and stuffing. Part of the entertainment value of the toy is the ability of the user to be part of the toy's process of manufacture. In these types of on-demand and self-service manufacturing methodologies, the user is present for the toy's creation and construction, and the toy is often more personalized because the user has made personal decisions about the design of the toy. This can include decisions as to the toy's design and what additional components or functionality it includes.

In effect, the toy becomes more capable of reflecting the toy's owner because its owner is also, in many respects, its creator and builder. This is beneficial both for children in making customized toys and for toys which are given to the child. The latter results in the toy often having a more personal connection as it is associated by the child with the person who made and gave the toy to the child because of the personalization. Further, the very process of building a toy is “play” which emulates modern manufacturing and construction techniques and can provide entertainment and learning as well. Further, toy stores are also increasingly becoming play destinations where the toy is viewed as a “friend” or “companion” allowed to take part in the child's activities instead of an inanimate object.

Personalization and anthropomorphism of toys by children as part of their play is not new. The “reality” of toys as things other than inanimate objects has been fertile ground for children's literature and entertainment for many years and virtually every child, at some time, sees a toy as more than just an object. It has long been recognized that children have a more difficult time separating fantasy from reality than adults and, therefore, such anthropomorphism is easily understood. Further, anthropomorphism of toys can allow a parent to use a child's imagination to assist in dealing with problems created by a child's imagination. Child-rearing books are filled with examples of using a child's plush toy, and a child's imagination, as a powerful hero that can defend the child from a child's imagined “monsters under the bed.”

Particularly when it comes to plush toys, the desire of children to anthropomorphize the toys can be strong. Such toys are very often comfort objects for children and are often used to calm and reassure children. A teddy bear going through an X-ray scanner prior to a child is a common image. Thus, there is often a natural push that plush toys are seen by children as real “people”. This particular anthropomorphism, and the specificity with which it is associated with a particular plush toy, leads to a need for play stations and a toy assembly workshop where the particular plush toy, regardless of its construction, is able to interact with the play environment as a “person” instead of a “thing”.

Thus, while many sophisticated plush toys include computer chips as part of their construction to allow interaction with other digital devices, it is often not desirable that the play environment requires a toy to be a sophisticated digital device in order to interact. Instead, having a digital play area that can interact with non-digital devices, or devices with only small unobtrusive digital components, can provide a wider interactive play experience. Further, having the play environment be hands-on, engage multiple senses, and provide for motor movement can be desirable.

Still further, play environments which can utilize now ubiquitous digital technologies to further enhance the personalization, and in some respects anthropomorphism, aspect of plush toys can be desirable.

### SUMMARY

Because of these and other problems in the art, described herein, among other things, are systems and methods for providing an interactive toy assembly workshop and methods for making a toy which utilizes a digital profile so as to be increasingly personalized. The workshop is composed of a variety of stations which are specifically related to various assembly tasks in the process of taking an unfinished plush toy and producing a finished toy design. While some of these stations are geared to more hands on tasks in selecting and actually assembling the toy, others are specifically designed to provide interactive experiences that enhance the personality of the toy, make it unique, and provide for it to be anthropomorphized by the user in a particular way by creating and using a digital profile with the toy.

There is described herein, among other things, a method for associating characteristics to a non-digital device, the method comprising: providing a non-digital device, the non-digital device being uniquely identifiable via an indicia attached to the device; at a first station: creating a digital profile for the non-digital device; associating the digital profile with the indicia; and populating the digital profile with characteristics; at a second station: obtaining the characteristics via the indicia; and displaying the characteristics as being from the non-digital device.

In an embodiment of the method, the non-digital device comprises a toy.

In an embodiment of the method, the toy is a plush toy.

In an embodiment of the method, the indicia comprises a machine readable code on a removable tag attached to the plush toy.

In an embodiment of the method, the characteristics are personality traits for the plush toy.

In an embodiment of the method, the second station comprises a station for physically assembling the plush toy.

There is also described herein a workshop for assembling a toy, the workshop comprising: a station network interconnecting: a selection station; a characteristic station; a stuffing station; and a checkout station; wherein a toy is selected at the selection station; wherein characteristics are assigned to the toy at the characteristic station, the characteristics being stored as a profile in the station network; and wherein the stuffing station and the checkout station access the profile to display the characteristics of the toy.

In an embodiment, the workshop further comprises an interactive storefront.

In an embodiment of the workshop, the interactive storefront includes a game.

In an embodiment of the workshop, a machine readable indicia attached to the toy is read at each of the stations to access the profile.

In an embodiment, the workshop further comprises a sound station.

In an embodiment of the workshop, the sound station also accesses the profile to display the characteristics of the toy.

In an embodiment, the workshop further comprises a dressing station.

In an embodiment of the workshop, the dressing station also accesses the profile to display the characteristics of the toy.

In an embodiment, the workshop further comprises a setup station.

In an embodiment of the workshop, the setup station also accesses the profile to display the characteristics of the toy.

In an embodiment of the workshop, the setup station connects the profile to identifying information of an owner of the toy.

In an embodiment, the workshop further comprises a washing station.

In an embodiment of the workshop, the washing station also accesses the profile to display the characteristics of the toy.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1 provides a left front perspective view of an embodiment of an interactive toy assembly workshop.

FIG. 2 provides a right front perspective view of the embodiment of an interactive toy assembly workshop of FIG. 1.

FIG. 3 provides a right front perspective view of the embodiment of an interactive toy assembly workshop of FIG. 1 from the selection station inside the main entrance.

FIG. 4 provides a left rear perspective view of the embodiment of an interactive toy assembly workshop of FIG. 1 from the dressing station about 1/3 of the length of the workshop from the rear wall.

FIG. 5 provides a left rear perspective view of the embodiment of an interactive toy assembly workshop of FIG. 1 from the rear wall.

FIGS. 6A and 6B provide various views of an embodiment of an interactive storefront. FIG. 6A provides a front perspective view showing a representative screenshot of an embodiment of a teaser game. FIG. 6B shows a front elevational view.

FIGS. 7A-7F show various views of an embodiment of a choice station. FIG. 7A provides a rear perspective view while FIG. 7B provides a front perspective view. FIG. 7C shows a front elevational view, FIG. 7D shows a left side elevational view, FIG. 7E shows a rear elevational view, and FIG. 7F shows a top view.

FIG. 8 shows a front perspective view of three choice stations of FIGS. 7A-7F arranged together into one leg of a selection station and including additional displays.

FIGS. 9A-9C show various additional views of the selection station leg of FIG. 8. FIG. 9A shows a front elevational view, FIG. 9B shows a right side elevational view, and FIG. 9D shows a top view.

FIGS. 10A-10F show various views of an embodiment of a characteristic station. FIG. 10A shows a front perspective view and FIG. 10B shows a detail perspective view of the base. FIG. 10C shows a front elevational view, FIG. 10D shows a left side elevational view, FIG. 10E shows a rear elevational view, and FIG. 1OF shows a top view with the overhead gear component is in dashed line for clarity.

FIGS. 11A-11E show various views of an embodiment of a sound station. FIG. 11A shows a front perspective view, FIG. 11B shows a front elevational view, FIG. 11C shows a right side elevational view, FIG. 11D shows a rear elevational view, and FIG. 11E shows a top view.

FIGS. 12A-12B show screenshots of an embodiment of basic data entry screens. FIG. 12A is for entering a birthday, FIG. 12B is a timed reset screen.

FIGS. 13A-13F show screenshots of an embodiment of a characteristics entry process. FIG. 13A shows a cue to place a heart on the screen. FIG. 13B shows a user placing a heart on the screen. FIG. 13C shows the heart having been detected and a cue to enter the user's name. FIG. 13D shows a characteristics entry screen. FIG. 13E shows the user moving a characteristic to the heart. FIG. 13F shows the heart with some characteristics therein.

FIGS. 14A-14E show various views of an embodiment of a stuffing station. FIG. 14A shows a front perspective view. FIG. 14B shows a front elevational view. FIG. 14C shows a rear view with the loading funnel removed. FIG. 14D shows a top view with the loading funnel removed, and FIG. 14E shows a top view of the loading funnel.

FIGS. 15A-15D show various views of an embodiment of a dressing station. FIG. 15A shows a front elevational view, FIG. 15B shows a left side elevational view, and FIG. 15C shows a top view. FIG. 15D shows the station of FIG. 15A with an embodiment of signage attached.

FIGS. 16A-16E show various views of an embodiment of a setup station. FIG. 16A shows a front perspective view, FIG. 16B shows a detail perspective view from the opposing direction. FIG. 16C shows a right side elevational view, FIG. 16D shows a front elevational view, and FIG. 16E shows a top view.

FIGS. 17A-17I show various screenshots for an embodiment of a characteristic activation process on a setup station. FIG. 17A shows a cue to scan a toy. FIG. 17B indicates to place a toy on the screen. FIGS. 17C and 17D show different toys being detected. FIG. 17E shows the scan screen for the toy of FIG. 17D. FIGS. 17F and 17G show the toy (53) being evaluated. FIGS. 17H and 17I show a final characteristic add.

FIGS. 18A-18G show various screenshots of an embodiment of a naming and linking process on a setup station. FIG. 18A shows a general setup selection screen. FIG. 18B shows an owner name entry screen. FIG. 18C shows a toy name entry screen. FIG. 18D shows an owner address entry screen. FIG. 18E shows an owner contact information entry screen. FIG. 18F shows a verification screen. FIG. 18G shows a birth certificate creation screen.

FIG. 19 shows an embodiment of a birth certificate for a toy.

FIG. 20 shows a front perspective view of an embodiment of a checkout station.

FIG. 21 shows a storyboard for control of a stuffer such as that of FIGS. 14A-14E

FIGS. 22A and 22B show two different views of a portable station. FIG. 22A shows a front view of a portable stuffing station and FIG. 22B shows a rear view of a portable stuffing station.

FIG. 23 provides a front perspective view of an embodiment of a tabletop sound station.

FIG. 24 provides a screenshot of a software-based sound station running on a Smartphone.

FIG. 25 provides a screenshot of a software-based dressing station running on a Smartphone.

### DESCRIPTION OF THE PREFERRED EMBODIMENTS

An interactive toy workshop will generally be composed of a variety of play stations. These play stations will often provide a mixed reality, enhanced reality, or augmented environment that comprises both real and virtual elements. In other words, the simulation utilizes a tangible environment—not a mere virtual environment where the user interacts via an interaction device (such as, but not limited to a computer keyboard or pointer (mouse)) or via an avatar of themselves on the screen. It is an environment where they can touch, feel, smell, hear, and otherwise directly engage their senses and utilize motor skills outside of those required by interaction with mere simulation, but which can result in virtual simulation of various activities which serves to personalize a toy.

In an embodiment, the digital control of the environment is camouflaged so that a user is not necessarily aware that they are providing digital input and at least some of the workshop stations utilize an interconnected digital network (generally referred to as the “station network”) to obtain and share digital information. This digital information is called a “profile” herein, is stored in a memory attached to the station network, and is associated with a particular toy. The profile may include information about the user of the workshop that is creating the toy (e.g. the user and/or family associated with the toy), the owner of the toy (the child that would be expected to play with it), the toy itself (e.g. its style or where its constituent parts were built), and/or characteristics ascribed to the toy by the user.

This last item will generally have no physical counterpart on the toy, but is simply an emotive component anthropomorphizing the toy. The profile is, in many respects, simply a database entry corresponding to the toy which is accessed when the toy is referenced. The stations utilize information in the profile to react to the user's actions so that the toy is treated more like a person during the workshop interaction.

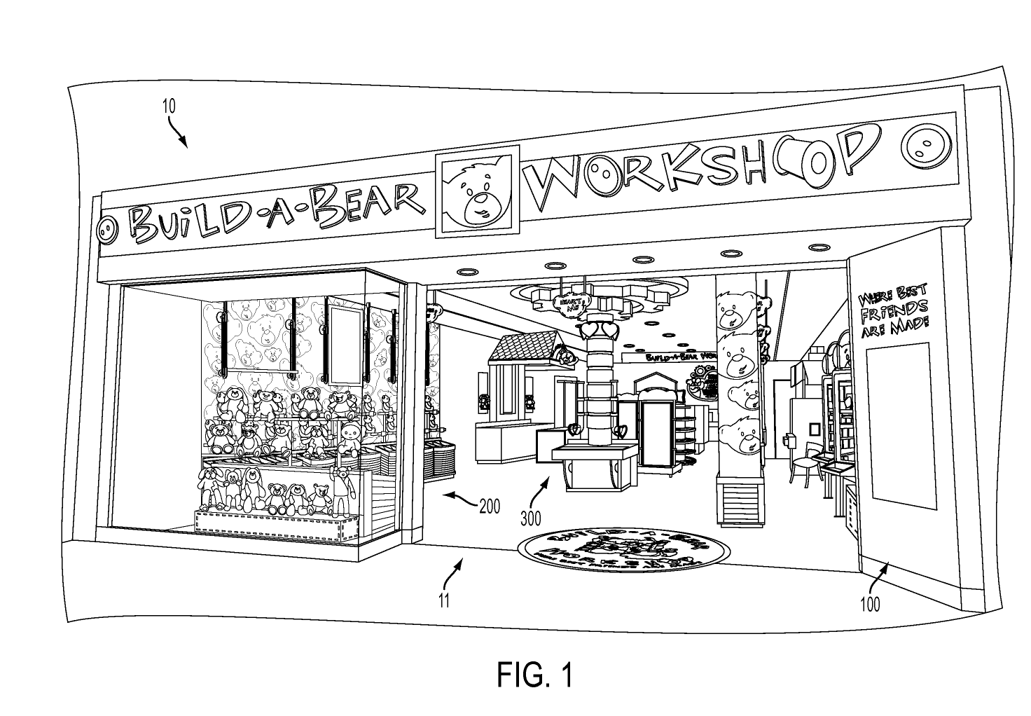

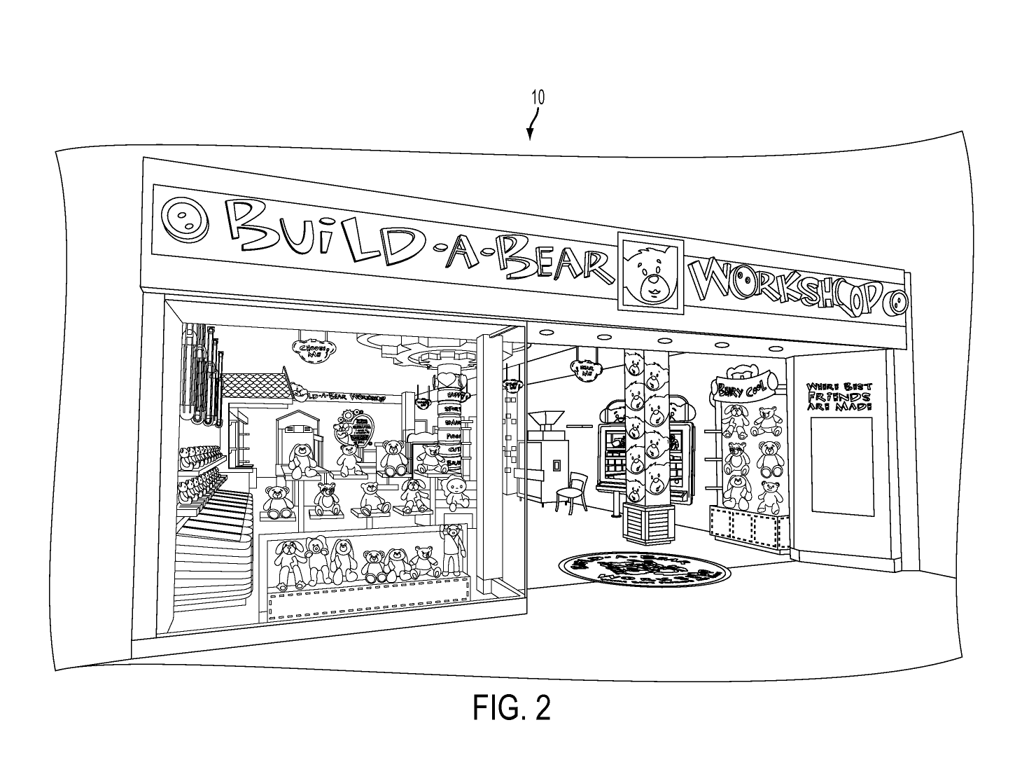

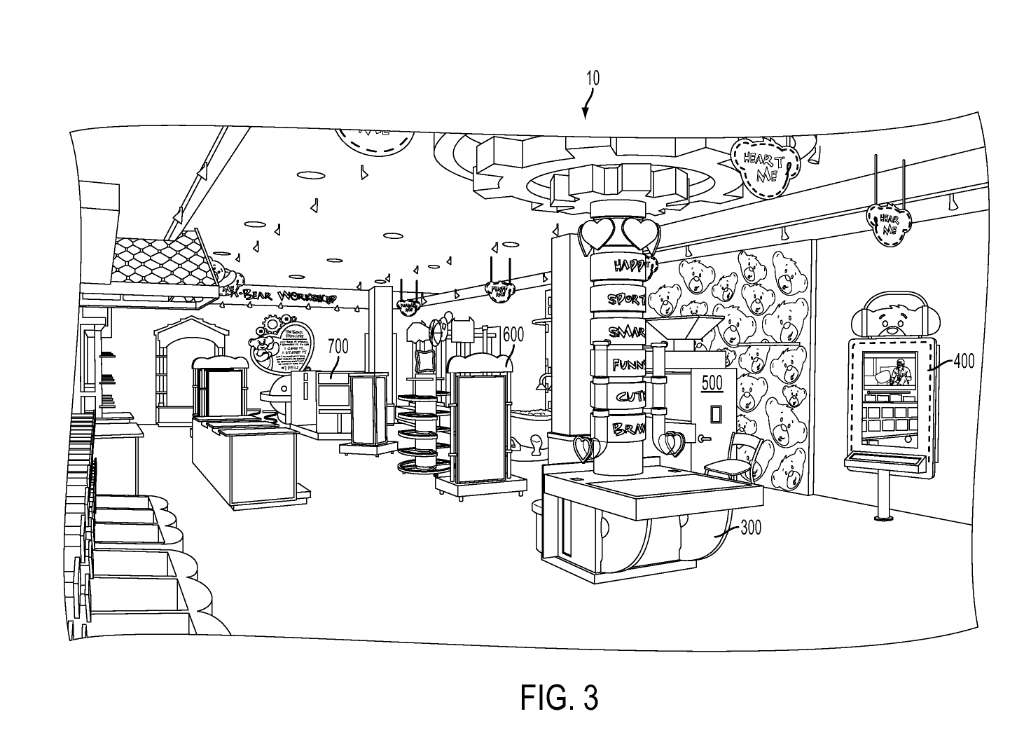

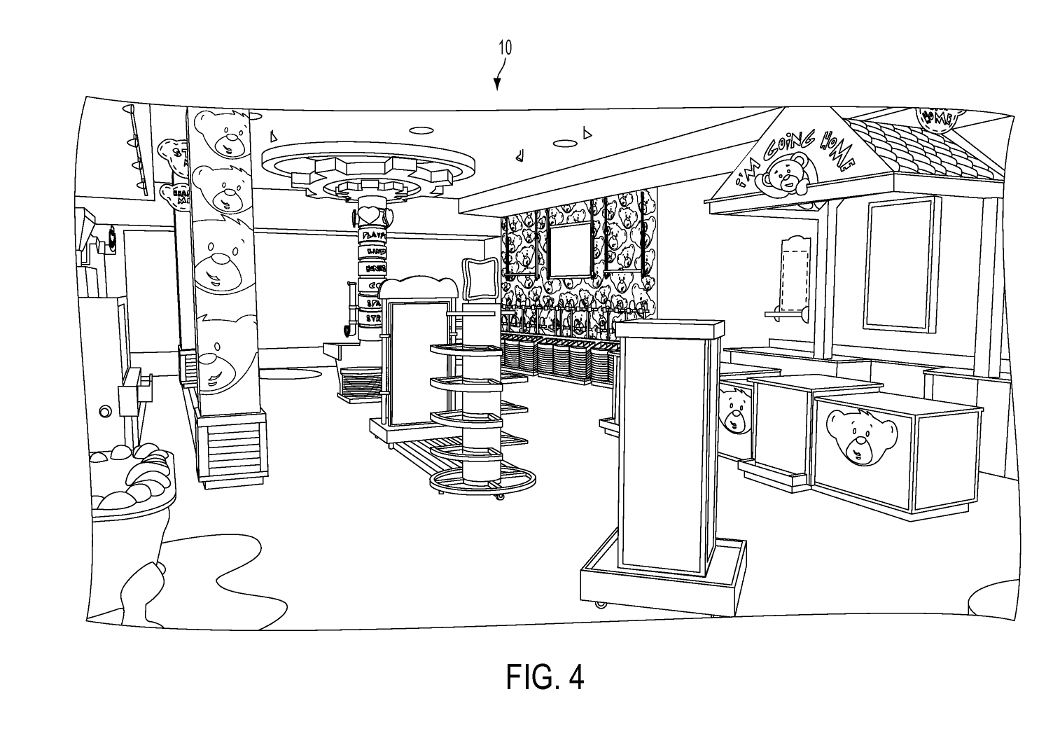

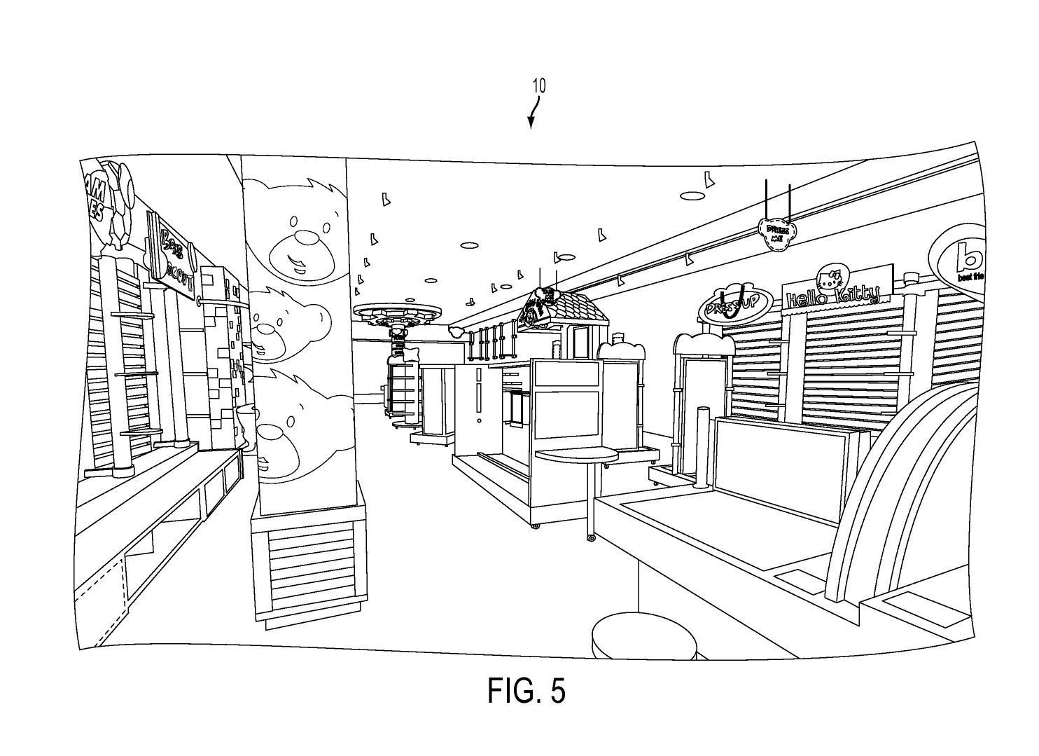

FIGS. 1-5 provide for various views of an embodiment of an interactive toy workshop (10). The workshop (10) comprises a number of play areas or “stations.” These stations serve a variety of functions. Specifically, they are designed to provide for necessary tasks in the creation of a toy (53). At the same time, they are also designed to allow a user in the interactive workshop (10) to personalize their toy (53) as part of the play experience and to receive a personalized experience in the workshop via an enhanced reality experience where the toy (53) is treated as “coming alive.” Separate stations are used as it provides for a physical environment that the user navigates during the process and therefore also adds more to the enhanced reality experience. Each station provides a particular activity, but the various activities together comprise a play experience.

The exact number and function of stations is variable depending on what types of activities are to be performed, however, in the embodiment of the workshop in FIGS. 1-5 there are shown 9 different stations (100), (200), (300), (400), (500), (600), (700), (800) and (900). These comprise an interactive storefront (100), a selection station (200), a characteristic station (300), a sound station (400), a stuffing station (500), a dressing station (600), a setup station (700), a checkout station (800), and a washing station (900).

A number of these stations are necessary to perform specific hands-on tasks related to the functions of building the toy (53). Other stations are designed to be digitally interactive to obtain information that is added to the profile of the toy (53) and may create purely non-physical data associated with the toy (53). Some stations may be hybrids of the two. All stations, however, are generally designed to provide for digitally interactive experiences in the form of an enhanced environment where the toy (53) is “brought to life” through the association of the physical toy (53) with digital information relating to it.

Each station will generally include a computer including various pieces of computer hardware including, but not limited to, digital processors, display devices, input devices, local storage, and communication hardware which hardware is effectively concealed in a station to enhance data collection and eliminate the need to utilize traditional computer interface tools to the extent possible. Each computer at each station will generally be in communication with the other stations in the workshop and may be in communication with remote computing tools such as storage devices and more powerful network machines in a manner well known to those of ordinary skill. They may also be in communication with other networks such as, but not limited to, the Internet. These types of networks of computers are well understood by those of ordinary skill in the art and the network including the station computers in any particular workshop will be referred to herein as the “station network.” The computer at any station can range from simply providing for digital signage and display, to being fully interactive and providing enhanced reality experiences. Some stations may also provide for no digital content to enhance the “reality” of the experience.

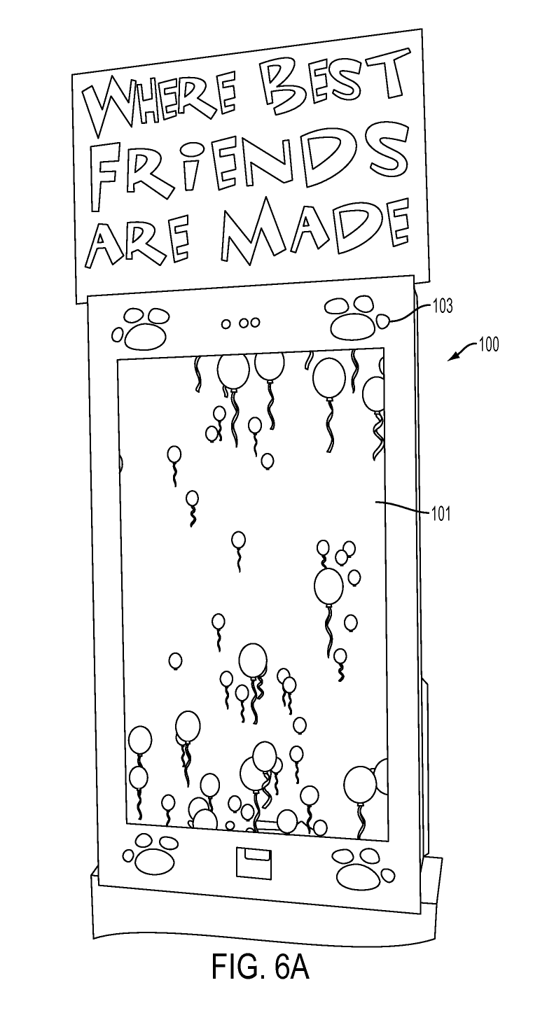

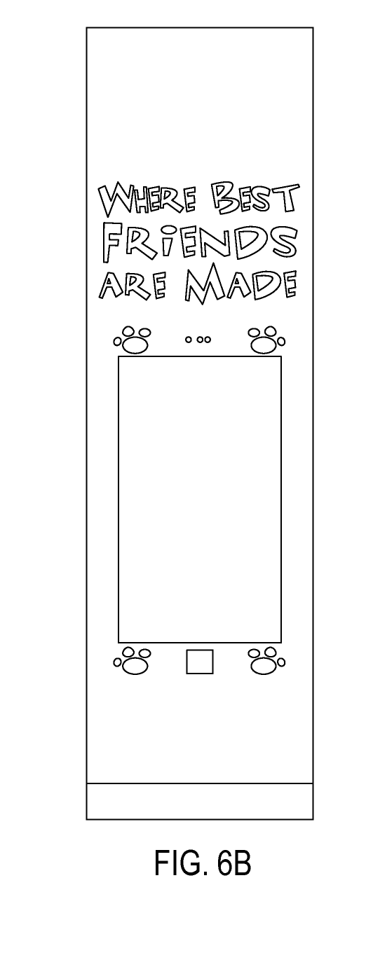

A user approaching the workshop (10) will generally first encounter the interactive storefront (100) which, as shown in the depicted embodiment of FIGS. 1-5, is at the entry point (11) of the workshop (10) and is generally outward facing. Detail views of an interactive storefront (100) are shown in FIGS. 6A and 6B. The interactive storefront (100) will generally be the first digitally interactive station encountered as it is designed to interact with users currently outside the workshop (10).

The interactive storefront (100) is usually a slightly different enhanced reality experience than most of the other stations as a user may, or may not, at that time have a toy (53) for interaction. Stations inside the workshop (10) are focused on generating or interacting with a user having a toy (53) with them, but the interactive storefront (100) usually must be accessible to a broader group. Because the interactive storefront (100) is at least partially intended to draw in potential users of the workshop (10), it is highly likely that a user will not have a toy (53) with which the interactive storefront (100) can interact and therefore is designed to more generally interact with potential users, while still being able to react to toys (53) if they are present.

The interactive storefront (100) will generally comprise a screen (101) which will often be transparent, partially transparent, or translucent so that one can see through it into the workshop (10). Alternatively, as shown in the depicted embodiment, the storefront screen (101) may simply be a standard display. The interactive storefront (100) can also include speakers (103) to provide for sound. It is preferred that the interactive storefront (100) have content running at all times when the workshop (10) is open (and possibly even when it is closed). This may be simple digital advertising, or may provide an interactive game as indicated later. In this way, a user walking past the screen (101) can immediately interact with the screen (101).

The interactive storefront (100) may include a scanner (307) for reading a machine readable indicia such as, but not limited to, a standard 2-D bar code, a 3-D bar code, a QR code, or any other machine readable code. The scanner (307) is a component which is common across a large number of stations as discussed herein and can be used to allow for the station, and the station network, to take in information from a user and identify a toy's (53) profile in a concise fashion. This information may come from a variety of forms.

The interactive storefront (100) may alternatively or additional include an imager or other device which is capable of obtaining images from the area in front of the interactive storefront (100) and interpret them. In an embodiment, the imager may comprise a 3-D scanner or camera which is viewing the area in from the interactive storefront (100). When an individual, possibly with a toy (53) enter the scanning area in front of the interactive storefront, the imager may be activated (e.g. through a motion sensor) and image the individual and or toy (53).

In an embodiment, the imager can then interpret the image. For example, if a child with a toy (53) entered the area, the imager may detect that the person was a child (e.g. because their image volume was of the size expected for a child and/or their facial features displayed more child-like features). It may also detect that the child is carrying a toy (53) and image the toy (53). The imager may determine that the toy (53) is a particular style of toy (53) that the workshop (10) carries, and may then alter the screen (101) content based on the toy. For example, if the toy (53) was a plush dog, the screen (101) may display an image of a toy cat running up a tree, or another toy dog may appear and “woof” a greeting. The imager can thus react to general information about the toy that is obtained, but generally cannot react to specifics of the toy. For example, while the imager can detect that the toy (53) is a dog, it likely would not know the name the child gave the dog (53).

The scanner (307), on the other hand, is generally designed to read information about a toy (53) by scanning a hang tag (57) on the toy (53) which allows for information about the toy (53) to be transferred between stations as the user moves through the workshop (10). The scanner (307), however, may also be used for enhanced marketing or user detection. It should be recognized that any function ascribed to the scanner (307) at any station herein can be ascribed to any other station as well. However, for ease of discussion, the scanners (307) at each station will generally only be discussed in conjunction with particular actions expected to be performed at that station in the depicted embodiment. Global actions will generally be discussed as taking place in the interactive storefront (100) simply because it is commonly the first station encountered, but they also could occur at any station (including home use and portable stations as discussed later).

In an embodiment, the scanners (307) may be used outside of toys (53) for marketing. Users may be provided with marketing mailers, emails, or other content which may include an indicia. This material could be to promote a certain item, provided as a reward, or to recognize an event (such as, but not limited to, a birthday). The content could be brought in and scanned by the user, (e.g. from a paper printout or from a screen display on an item such as, but not limited to, a Smartphone). This scanned information, whether from a mailer, frequent purchaser information, or even a special promotional toy (53) can serve to “unlock” special content on the station network. As used herein, the term “unlock” is used as is common in the digital entertainment industry that once a code is used to unlock special content, that content is now available to that user and possibly other users.

Upon scanning, the interactive storefront (100) could present individualized or semi-individualized content. For example, for birthday related content, the interactive storefront (100) could provide birthday related imagery and wish the user a “happy birthday.” This content is semi-individualized as while it acknowledges a specific event related to that user, it is not specific to that user and any user with birthday content could receive the identical message. In personalized content, the specific birthdate or user's name could be displayed so that message is not the same for all birthdays, but specific to that user. Further, a birthday mailer could unlock a variety of birthday content for the whole store. For example, every screen on every station, upon a birthday promotion being scanned, could provide a happy birthday message and could continue to utilize a birthday themed background (e.g. with presents and balloons) for a period of time or so long as a toy (53) whose profile has become associated with the birthday mailer due to their being scanned in close proximity, was continued to be scanned at various stations. Thus, an individual user may not only influence their experience with a promotion, but every person in the workshop's (10) experience.

Similarly, to unlocking specialized displays, the unlock could unlock special features. For example, a characteristic of “birthday” could become available in the characteristic station (300) below. Similarly, a special game could unlock which any user of any station at the time it was unlocked could play. The unlock feature could also unlock a special operating mode. For example, if the unlock was not just an unlock for a birthday occurring, but that there was a birthday party at the workshop (10) celebrating that birthday, the unlock could allow any or all of the stations to operate in a multi-user mode. For example, instead of a station having content geared toward a single child and single toy (53) being at the station, the station can provide content for multiple users to use the station at once. This can allow for a group (specifically the party) to move through the stations together in a collaborative experience.

It should be recognized that while birthday content is indicated as being unlocked, this is merely exemplary of the types of content that could be unlocked. The content unlock could be, but is not limited to, specific to a user (e.g. a birthday), could be specific to a toy (e.g. an anniversary of the first sale of that toy), could be specific to a promotion (e.g. the grand opening of a particular workshop (10)), or could be global (e.g. the commencement of a global sporting event such as the Olympics). In this way, the workshop (10) can become a play destination and there can be a desire to be at the workshop (10) when a special unlock becomes available. Still further, the unlock may not only be available for new toys (53) being made at the workshop (10) at the time. Any user with a toy (53) could potentially have access to the unlocked content and may be able to update their profile using the unlocked content.

In a still further embodiment, the interactive storefront could react to a frequent purchaser card being scanned. This could allow for specific information about the user to be displayed and the enhanced reality function to interact with the user individually. For example, the user's name could be displayed or the interactive storefront could inquire about the status of a particular toy (53) the user previously purchased. For example, the interactive storefront (100) could inquire about a previously assembled toy (53) the user called “Flash” by asking: “Do you have Flash with you today?” The user could also be provided with rewards for stopping by and scanning their card, or could be provided with check-ins and related badges or digital rewards (such as, but not limited to, those used by programs such as Foursquare™). These functions are all well understood by those of ordinary skill. As should be apparent, information from the frequent buyer card and the imager can be combined. For example, if flash was a dog toy (53), upon detection of the user by the scanner (307) and the imager detecting that the child is holding a toy (53) that corresponds to the shape, color, and size of the dog toy (53) that this child previously purchased at this store, the screen (101) could provide more direct content. For example, the screen could welcome Flash back to the store.

The interactive storefront (100) may also include interactive content. This may be in the form of an interactive game. In FIG. 6A there is shown a screenshot of a balloon popping game where a user can try to grab and pop balloons. It is generally undesirable for a user of the interactive storefront (100) to need to pick up a controller or other interface device which requires them to interact with the game using an interface device. Picking up the device results in a barrier to playing the game. Instead, it is preferred that the user by able to interact with the game by the direct movement of their body.

In an embodiment, this interaction is performed by having the game system be controlled by a motion sensing controller which is capable of detecting their body movement. One such device is sold by Microsoft Corporation under the name Kinect™. This system can be constantly scanning an environment just outside the workshop and can allow for a user to interact, either intentionally or inadvertently, with the entry game system as they pass by the entry. This pass-by effect on the game screen can result in a user slowing and/or stopping and beginning to interact with the interactive storefront (100). In an embodiment, this motion sensing controller can serve as the imager (discussed above) depending on the particular activity to be performed.

The interactive storefront (100) will generally not provide a particularly complex or involved game with a clearly defined victory condition. Instead, the game play will generally be quite simple and may involve simply manipulating digital figures on the screen, or may involve simplified tasks such as popping virtual bubbles, squashing virtual insects, slicing virtual fruit, or moving virtual puzzle pieces to allow for a user to intuitively grasp the game mechanics. The game play may be associated with the toys (53) of the workshop (10) and may directly interface with the workshop's (10) intended product as well.

In order to enhance walkthrough interest, the interactive storefront (100) may offer discounts on products to better players of the game, for simply playing the game, or may simply encourage players to go into the workshop (10) either through traditional advertising and marketing strategies, or through direct indications to do so.

In a still further embodiment, the interactive storefront (100) may be able to interact with existing toys (53) that a user may have with them. If a user of the interactive storefront (100) is a returning user, and they bring with them a plush toy (53) they had created in a prior visit (or obtained from another retailer or as a gift). If this toy (53) includes storage and communication devices and is designed to be interactive with the stations, or its presence can be determined by the scanner (301) and/or imager the toy (53) may be used by the interactive storefront (100) and a digital representation of the toy (53) may become involved in the game. Alternatively, a user could be queried for specific information from the profile to identify the user and/or toy (53) if sufficient information cannot be obtained. The toy (53) may be identified in a variety of ways and a variety of cues and the interactive storefront (100) may utilize any of the same methodologies.

Once a user has entered the workshop (10), the user will generally begin the process of assembling a toy (53). The user's actions in the workshop (10) will generally involve passing through the stations, generally in a relatively fixed order although some variation may occur, to allow the user to build their toy (53) and provide it with personality. It is important to note that a number of the stations are designed to impart a “personality” to the toy (53). While it should be recognized that the toy (53) is ultimately an inanimate object incapable of having a personality, the stations are designed to provide for the illusion of personality through the profile associated with the toy (53). Thus, the characteristics and other information placed in the profile, and the association of the profile to the toy (53) in a fashion that is relatively transparent can be important to maintain the illusion of the toy (53) having the personality indicated by the profile.

While a plurality of different unique toys (53) may be present at any time in the workshop (10), it should be noted that each toy (53) is not necessarily unique at the time of its original manufacture, or even when it is sent home with the user. For example, the workshop may have 10 different toys (53), but may have 10 essentially identical copies of each. Different toys (53) may be effectively indistinguishable from each other when not in the workshop (10) or prior to being associated with a user or owner. However, it is preferred that there be a way for the digitally interactive stations be able to identify the toy (53) and specifically connect the profile to the toy (53) so that the profile is consistently used to provide the illusion that the toy (53) is more unique than it may be.

By assigning the toy (53) a profile which comprises stored information associated with the toy (53) which can be retrieved by the station network (at any computer or device in communication with the station network), it effectively connects the profile which is unique, to the toy (53), which is not, to make the toy (53) unique. Loading of the profile can be from a variety of cues including from entry of information from the toy, from the user, or from the stations or other devices connected to the station network. Thus, when the cues are obtained, the toy's (53) profile is accessed which allows for information in the profile to be used in a fashion which identifies the toy (53). In most cases, the connection is made initially by scanning a hang tag (57) on the toy (53) (which does uniquely identify the toy (53)) to populate the profile. Then, pieces of information in the profile can be used to identify and load the profile at a later stage when the hang tag (57) may no longer be present.

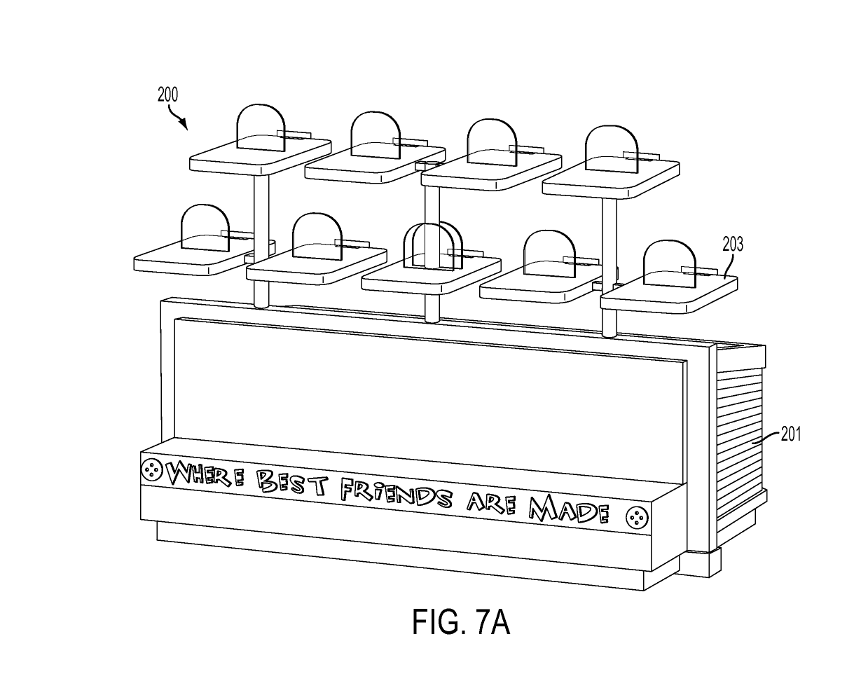

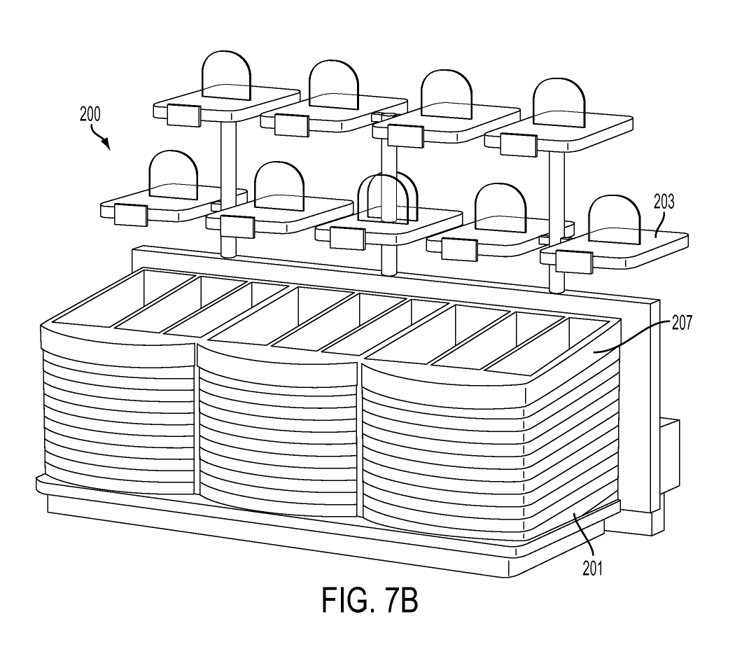

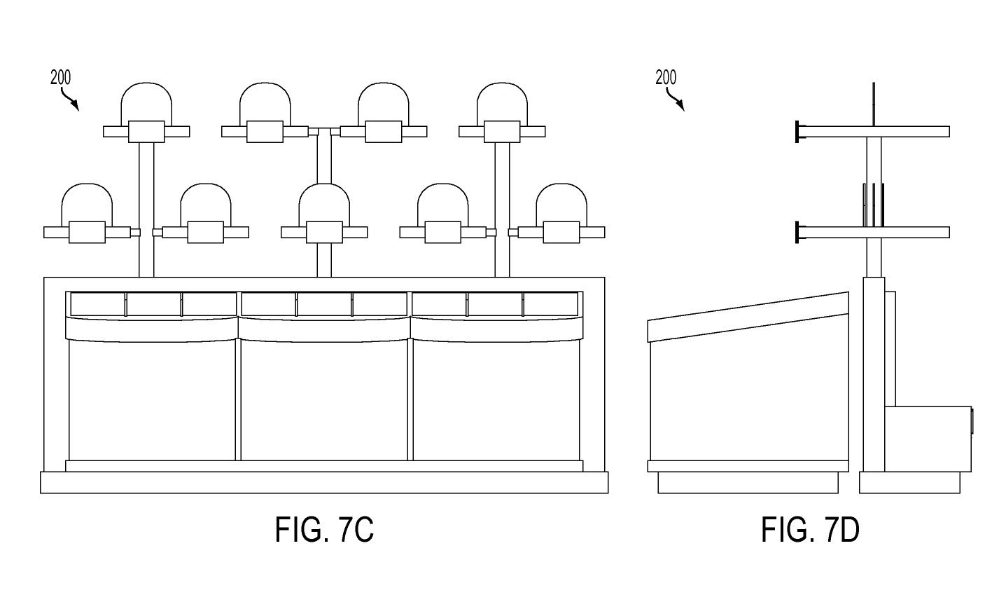

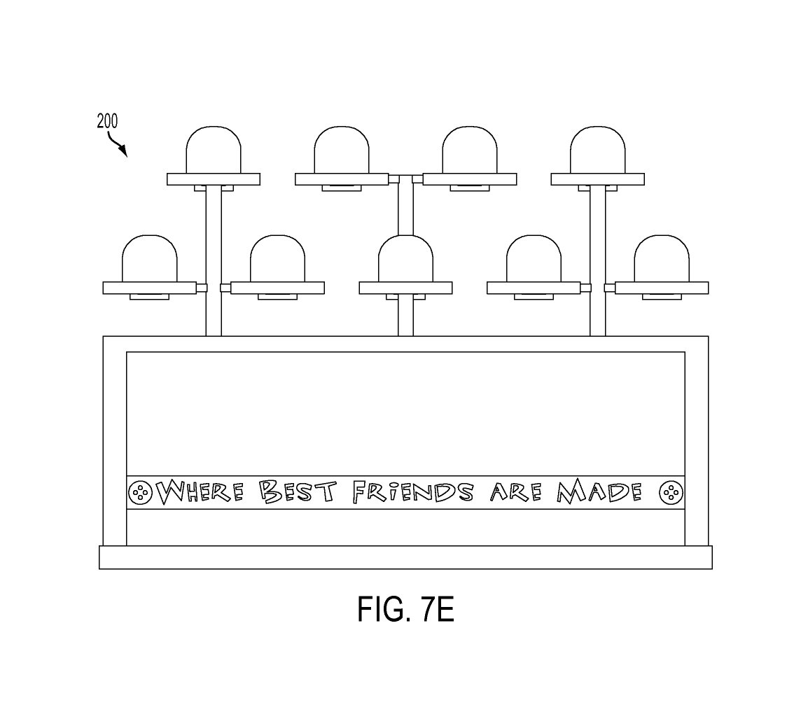

The first step of toy (53) assembly will generally take place in the selection station (200). The selection station (200) is composed of a plurality of choice stations (201) as shown in FIGS. 7A-7F. A choice station (201) is designed to display finished toys (53) on platforms (203) and/or on a display stand (205) depending on how it is positioned. As shown in FIGS. 1-5, the display stand (205) is generally used in a window display or two-sided display. The display stand (205) may be removable and added to the backside of certain choice stations (201) if both sides are visible as would be the case if the choice station (201) backed against a window, or may simply always be present and simply concealed against a wall on another station if not in use. The choice station (201) then includes bins (207) which may include raw toy (53) ingredients. In a plush toy (53) embodiment, this may comprise the shells of the plush toys (53) (e.g. the outer skins which have not been filled with stuffing).

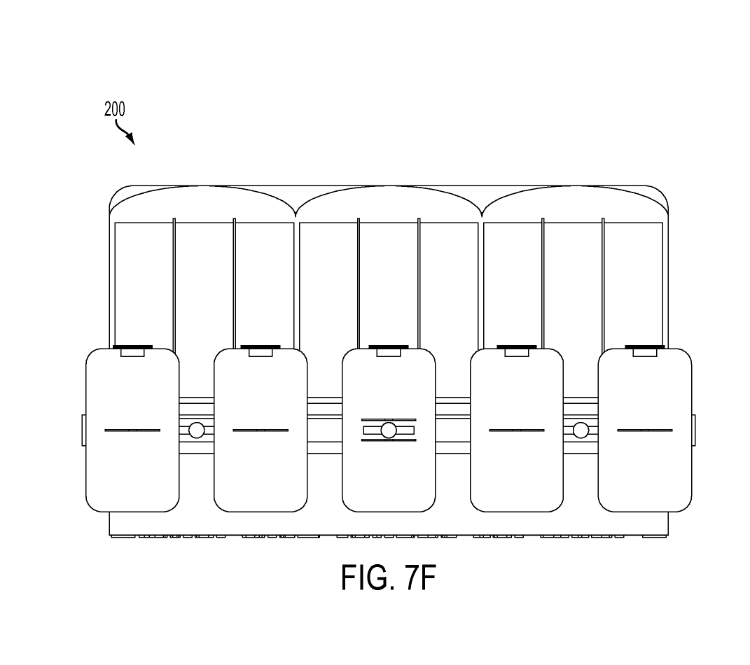

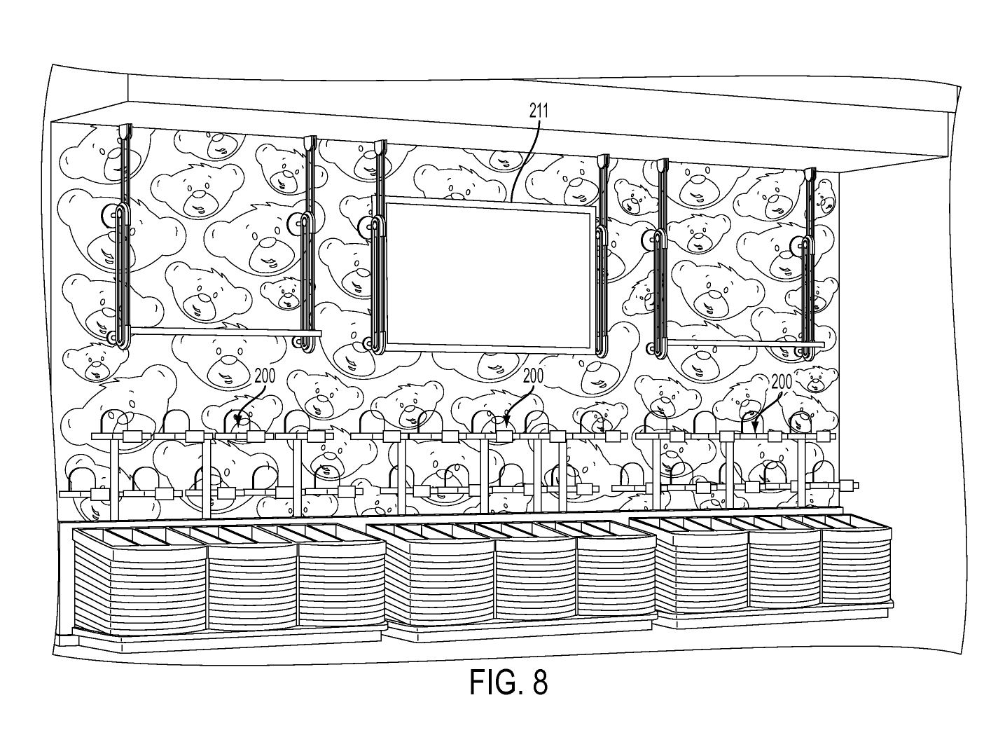

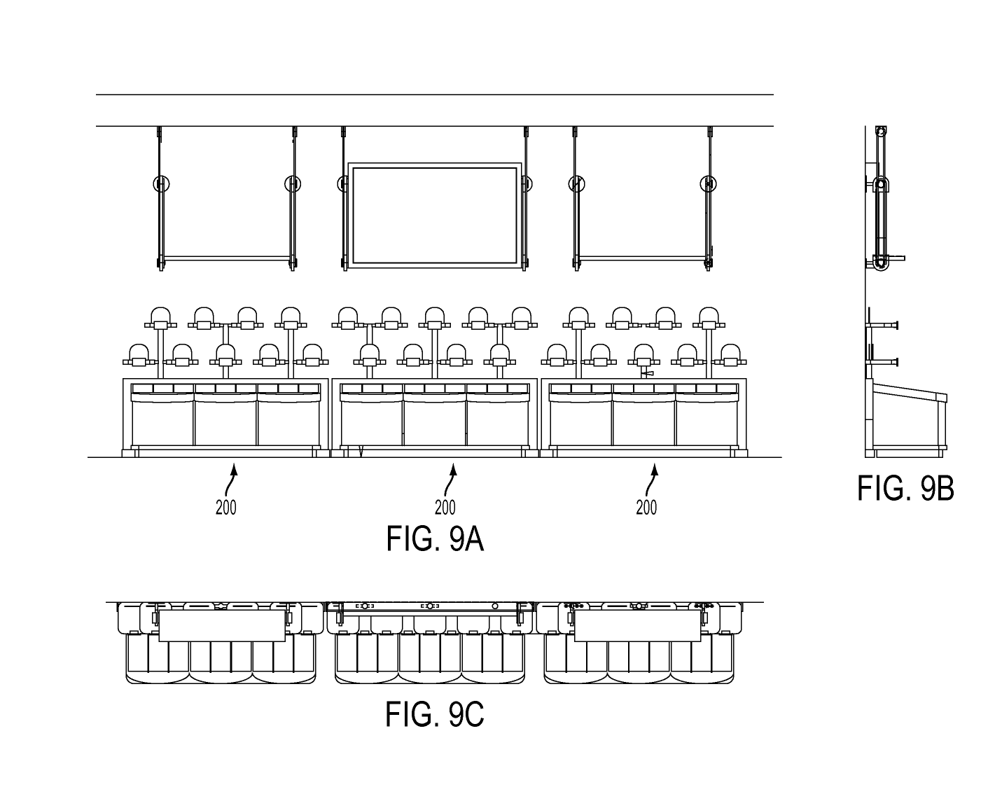

The selection station (200) is designed to allow for the user to make their initial selection of a particular toy (53) (generally based on their desire for the resultant toy (53) based on those on display). It is important to note that at the selection station (200), there may be digital media, such as on screen (211) as shown in FIGS. 8 and 9A-9C in order to provide for a more interactive experience and to introduce the user to the digital nature of many of the future stations. However, at this stage there is generally not a toy (53) to personalize as the user is in the very earliest stages of selecting which toy (53) they want. Once the toy (53) is selected, personalization may occur.

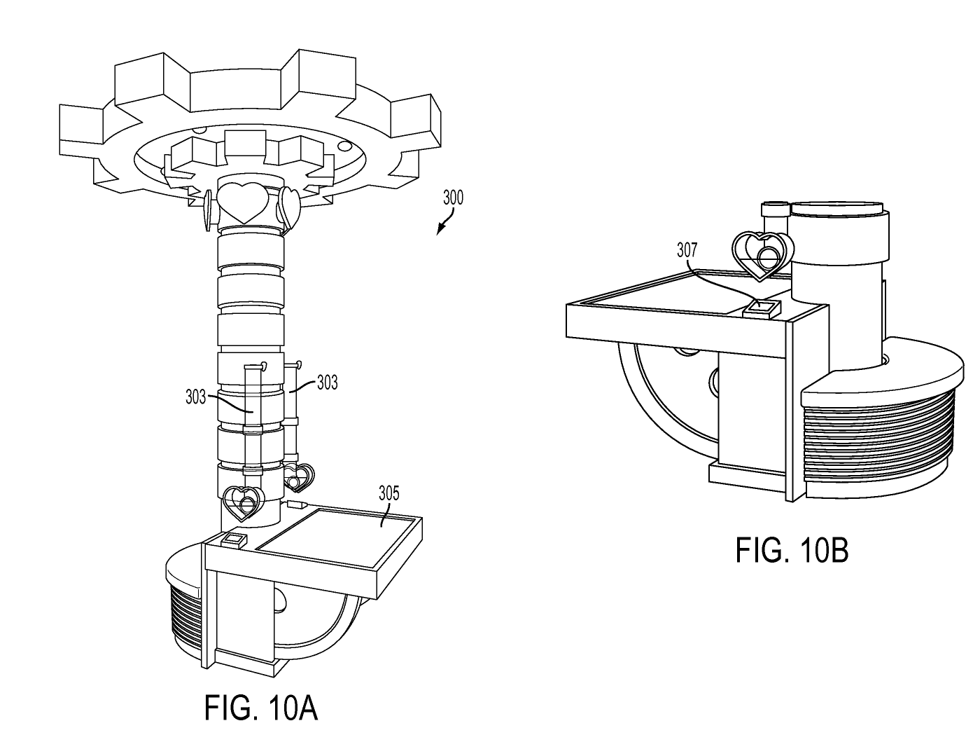

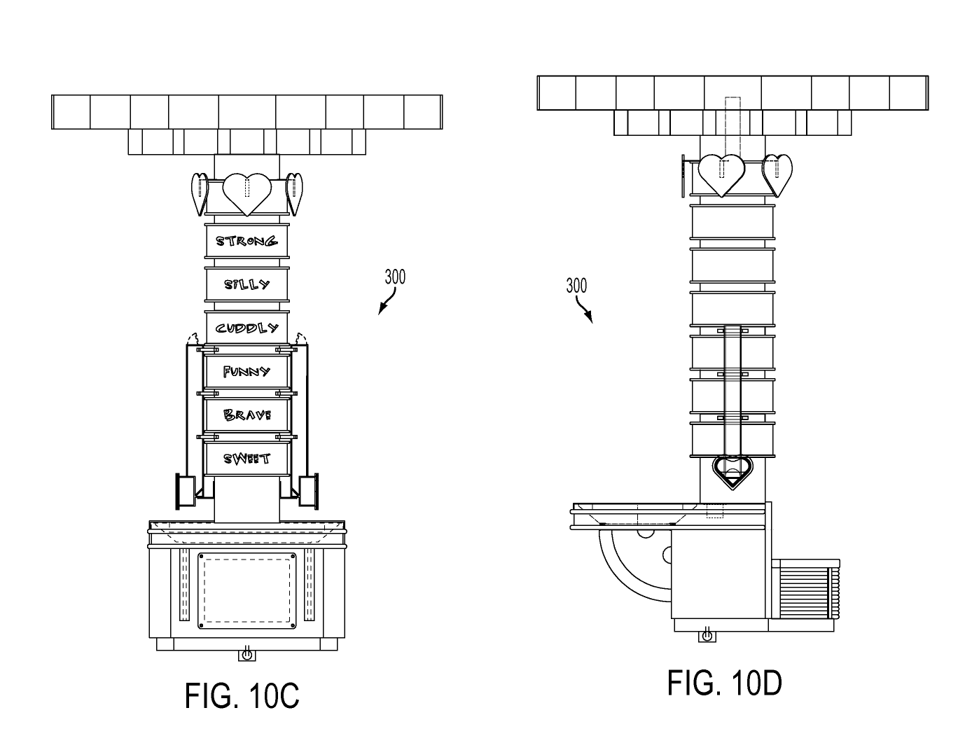

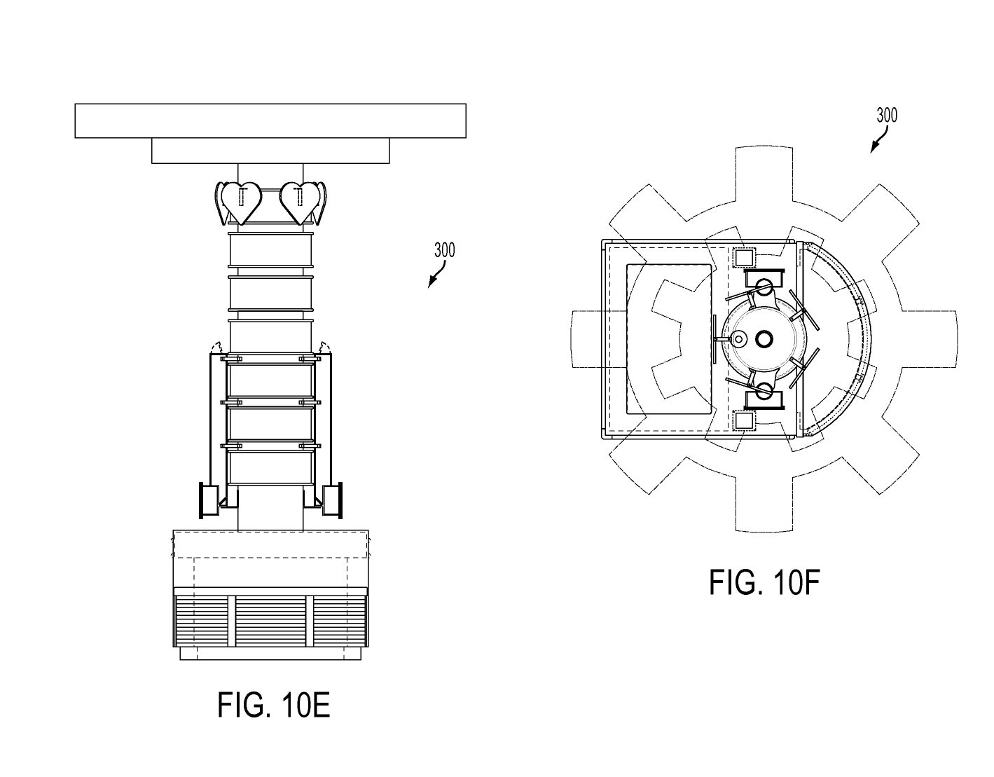

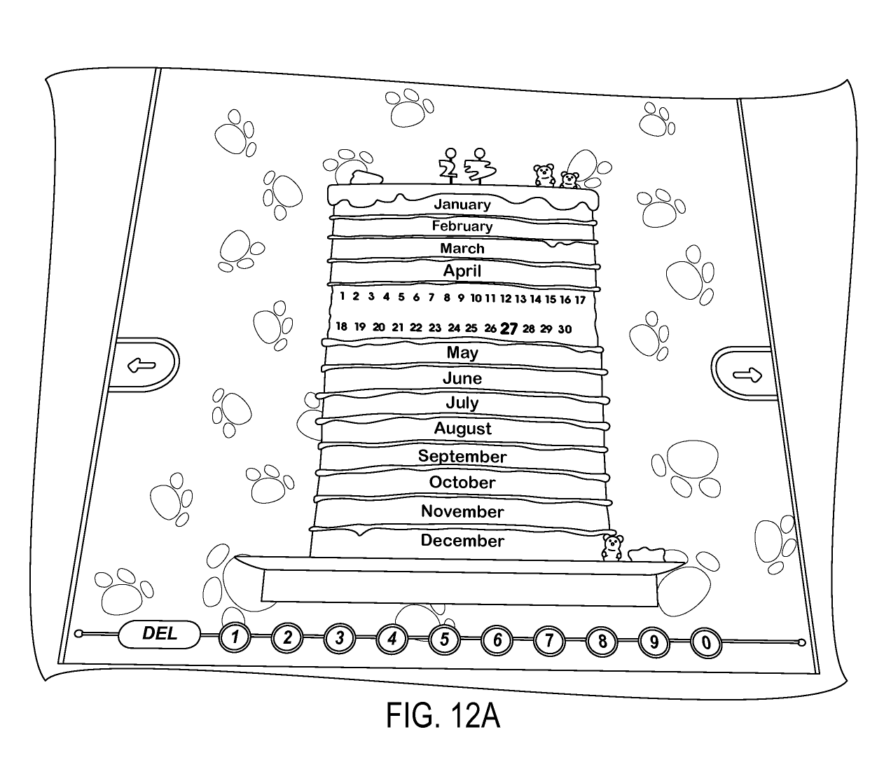

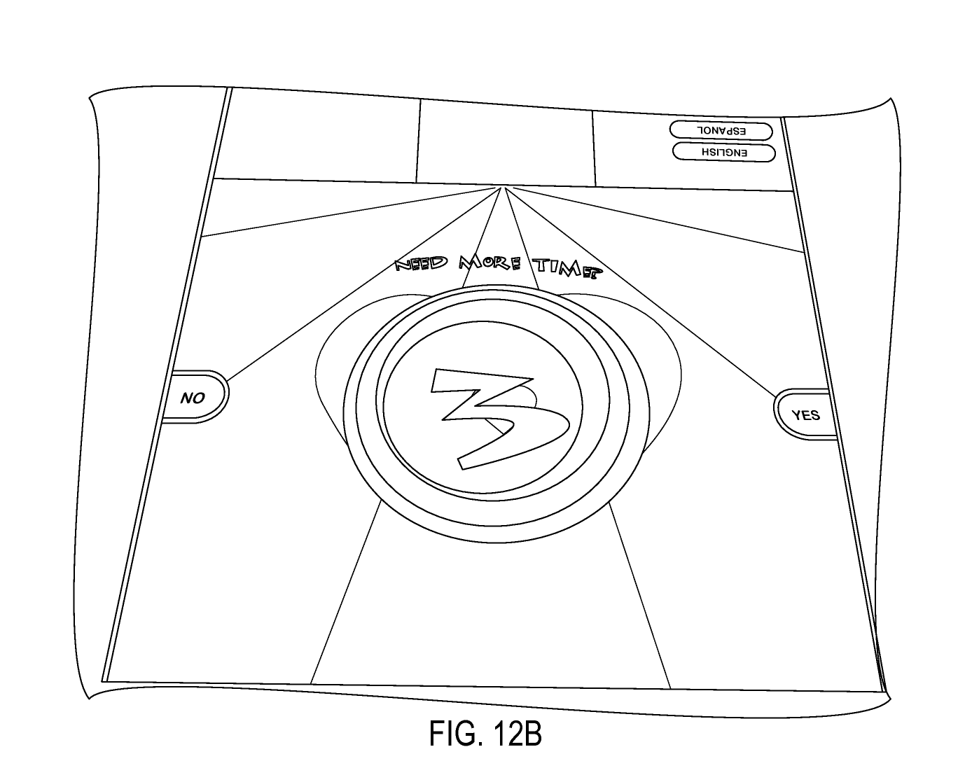

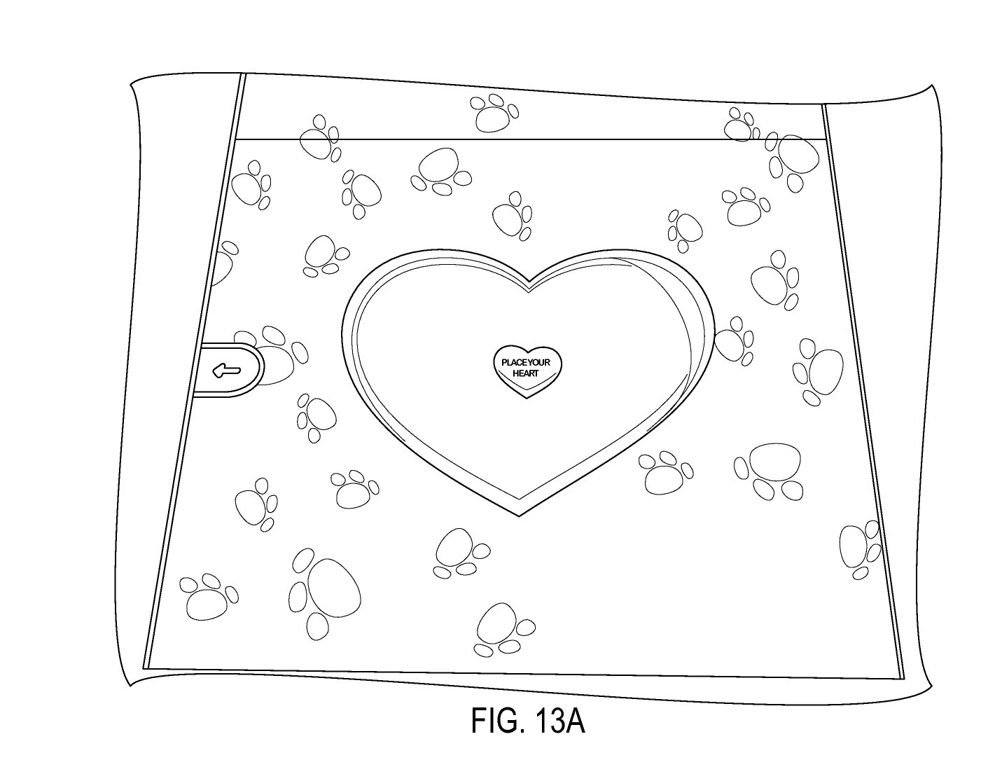

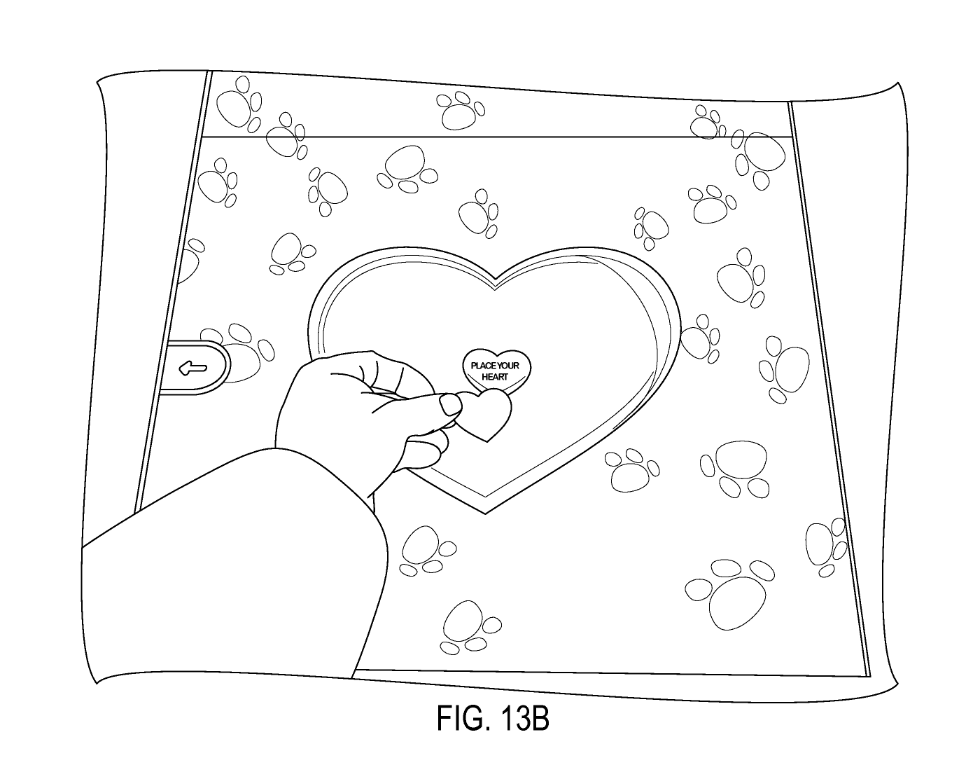

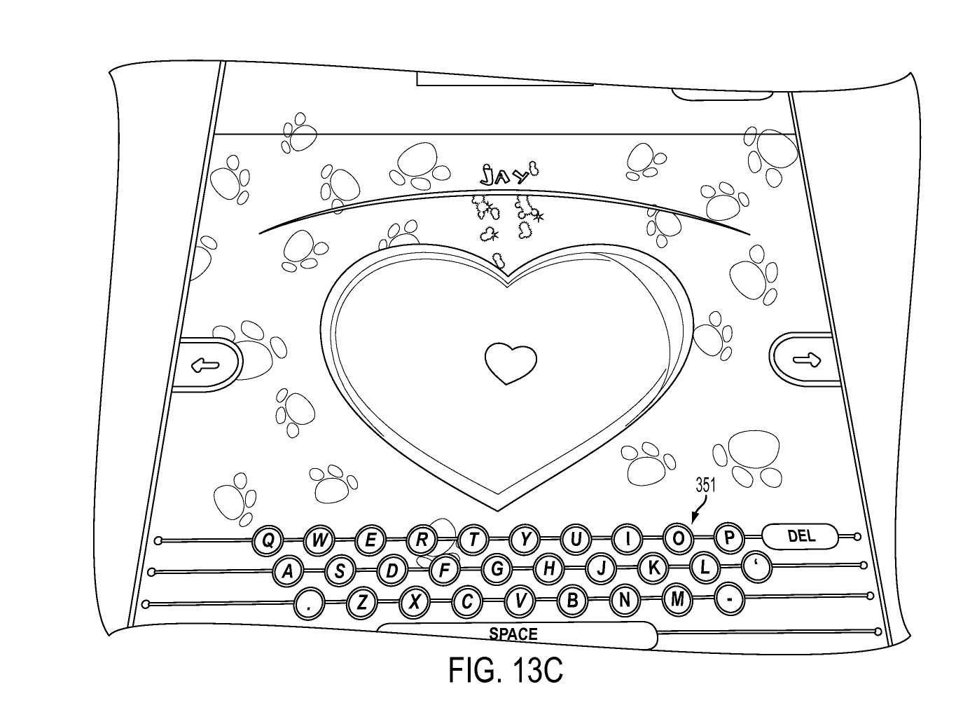

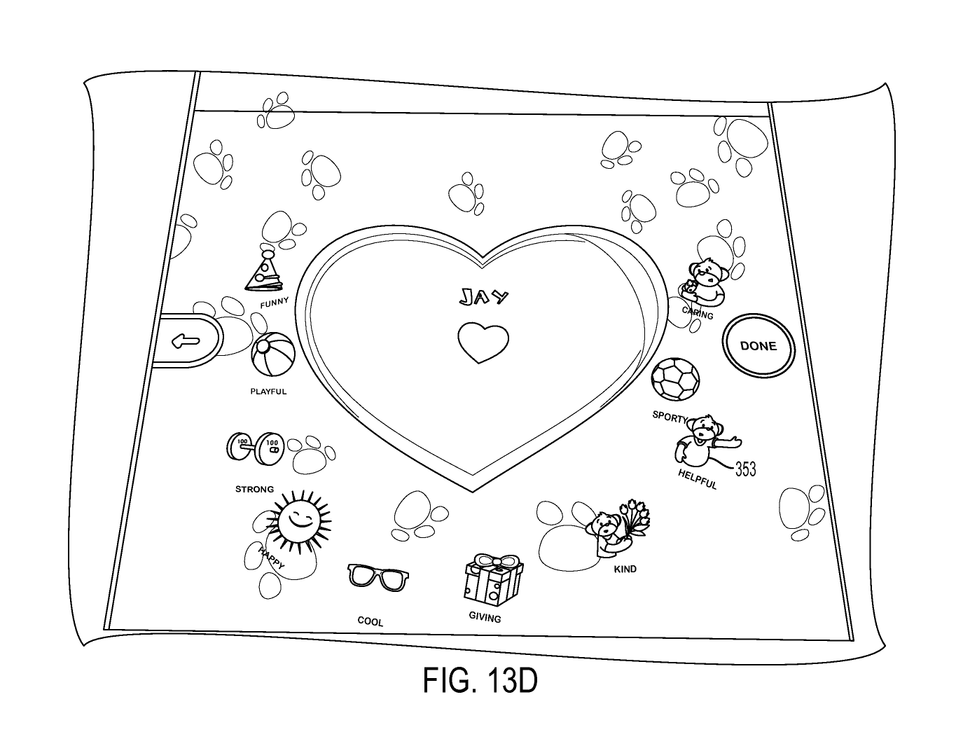

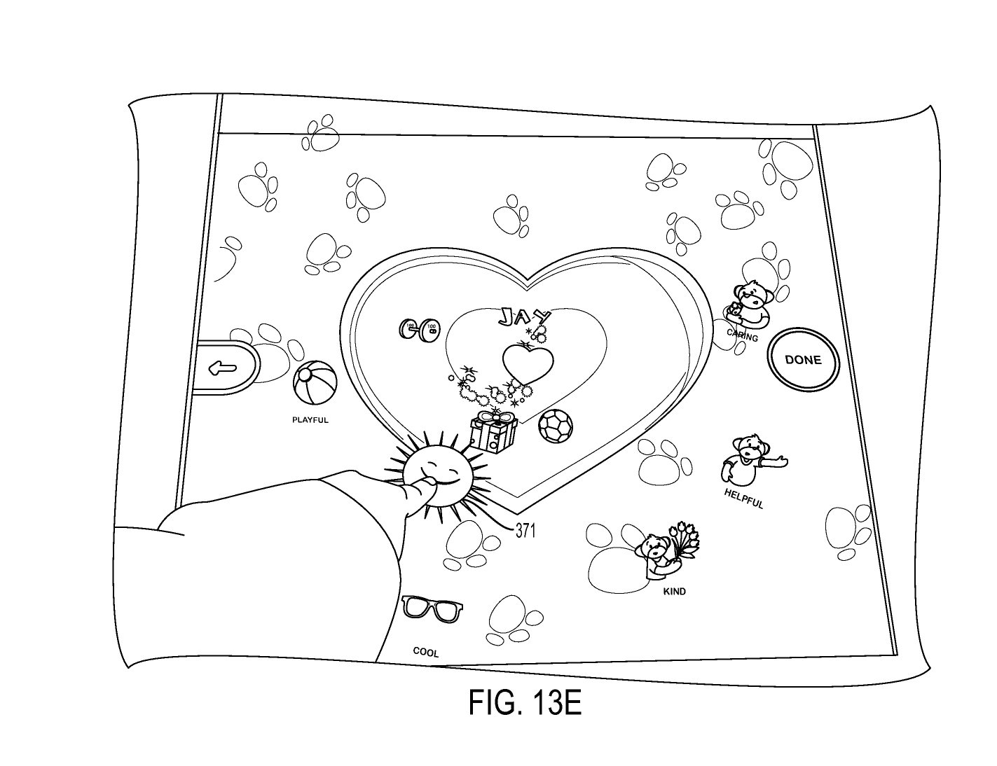

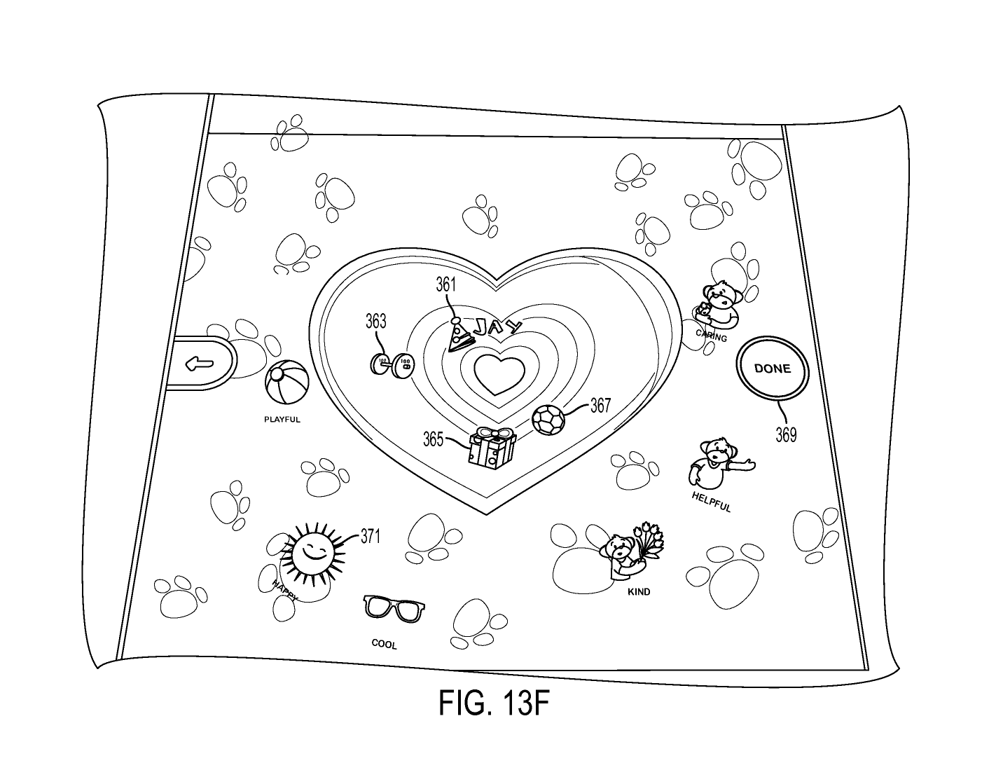

After the initial toy (53) has been selected, the user will generally move to the characteristic station (300), the characteristic station (300) is designed to provide for the initial specific characteristics and identity to the toy (53) and generally utilizes a digital interface to allow the user to enter the first information in the profile. FIGS. 10A-10F provide various views of an embodiment of a characteristic station (300) while FIGS. 12A, 12B, and 13A-13F provide for various screenshots of some basic operations and an embodiment of a characteristics entry process.

The characteristic station (300) will generally include an interactive display (305) acting as an interactive surface. One such display (305) is provided by a digital flat screen display device (305) placed on a shelf (307) so that its surface is at a height reasonable for allowing it to act as a table surface. The display (305) may also include any associated computer components necessary to carry out its operation as would be understood by one of ordinary skill, but these will generally be hidden internally. This includes, but is not limited to, memory components, digital processors, or more standard interfaces. In the depicted embodiment, control of the station (300) is performed by having the screen (305) be an interactive touch surface positioned at a position where it can effectively represent the plane of the table and having a user place and move objects on that surface.

In an embodiment, in order to initially identify the toy (53) to the station network at the characteristic station (300), the plush toy (53) shells can each include a hang tag (57) or other component which includes a unique machine readable indicia. This indicia may identify the specific type of plush toy (53) (e.g. is it a dog or a bear) but may also specifically identify the toy (53) via a unique inventory number or similar information. In the depicted embodiment, this indicia is placed on a paperboard hang tag (57) temporarily affixed to the toy (53) in a manner well understood by those of ordinary skill. In an alternative embodiment, the indicia can be more permanently attached to the toy (53) such as by being sewn on or printed on the toy's (53) surface.

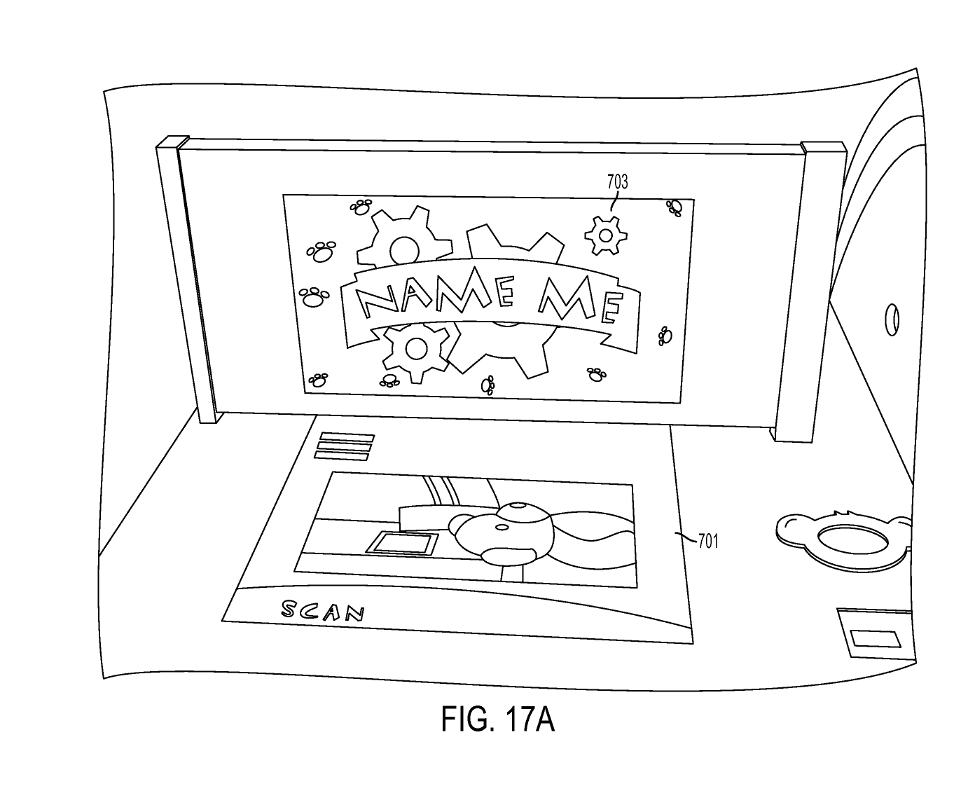

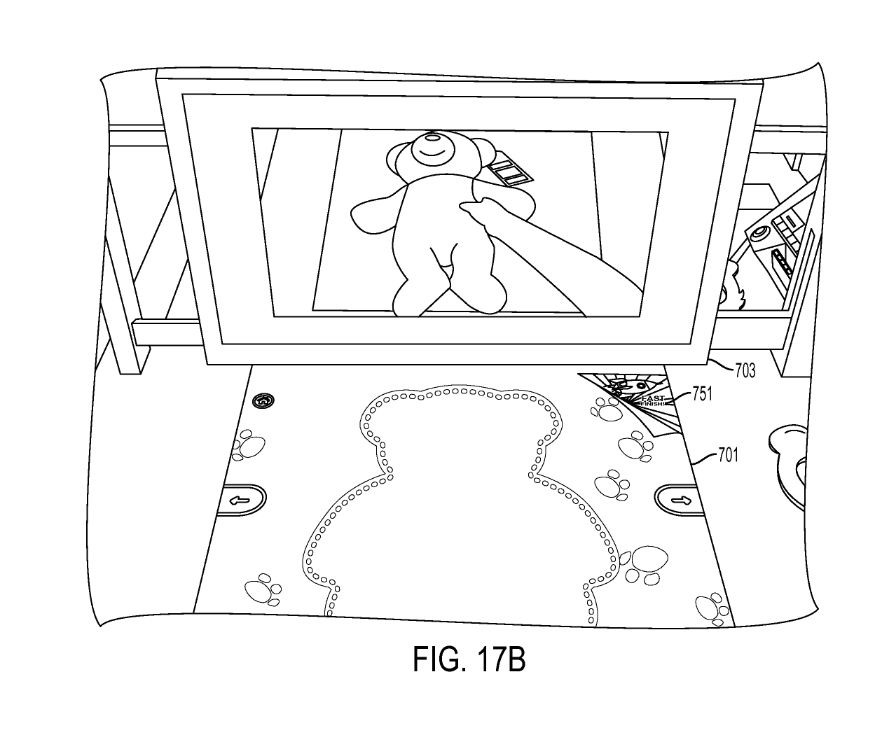

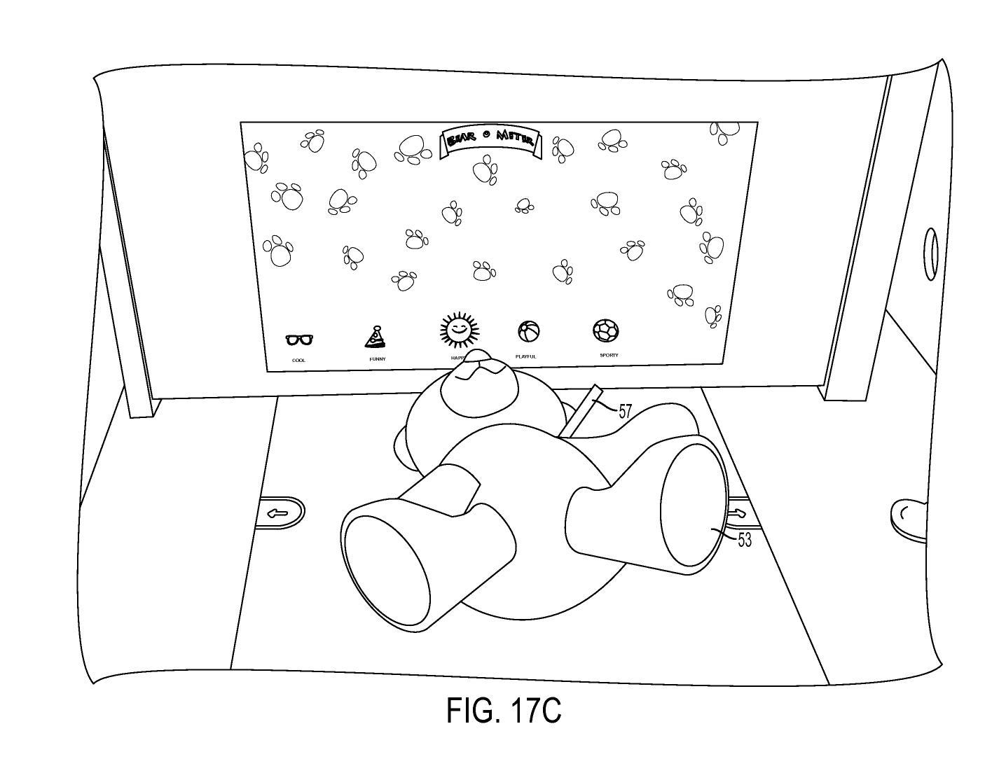

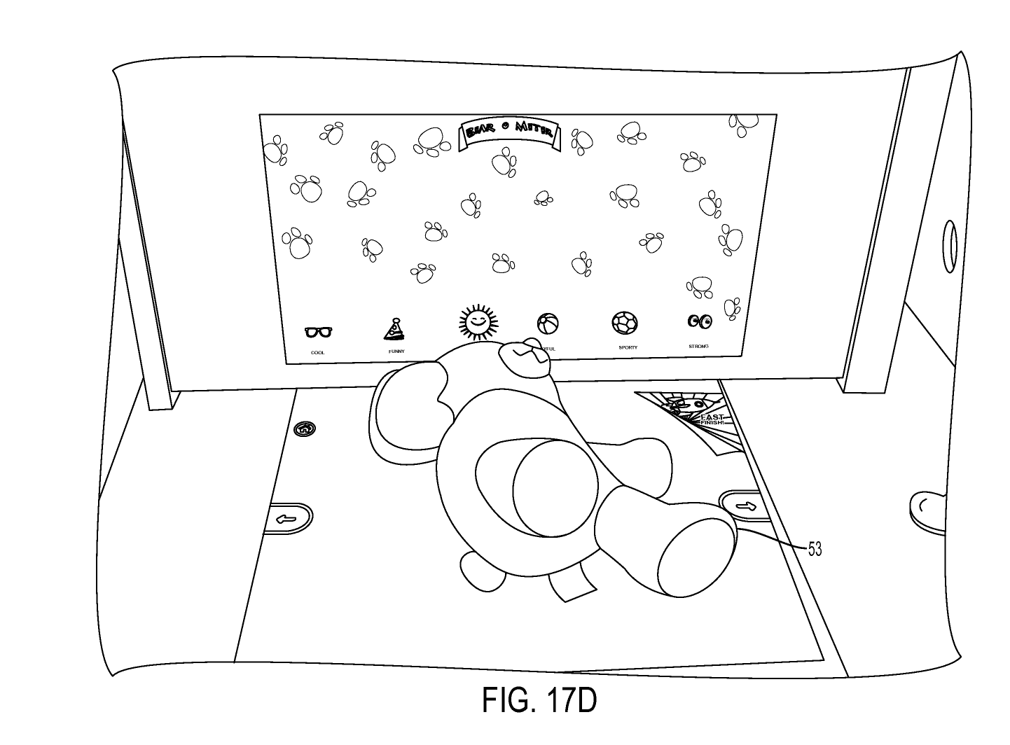

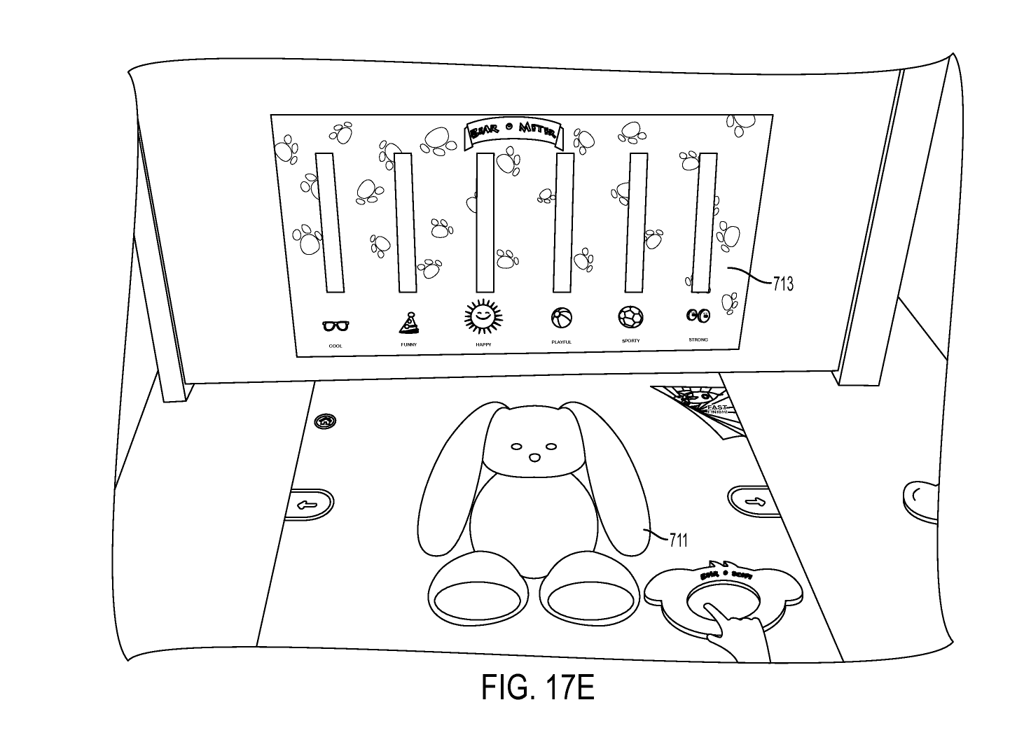

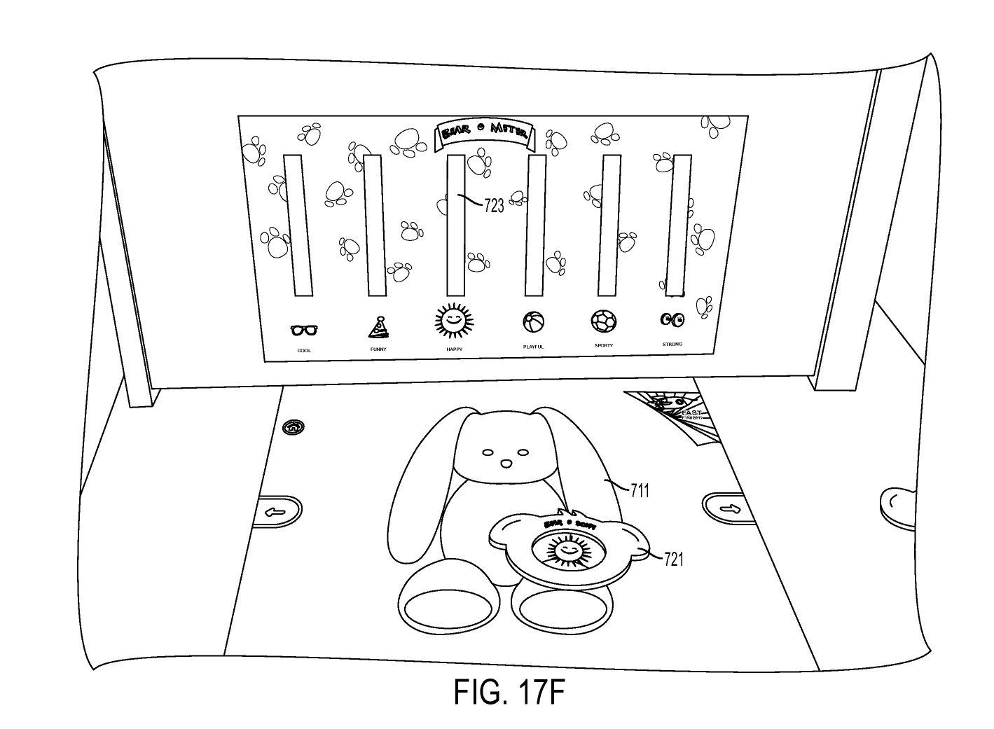

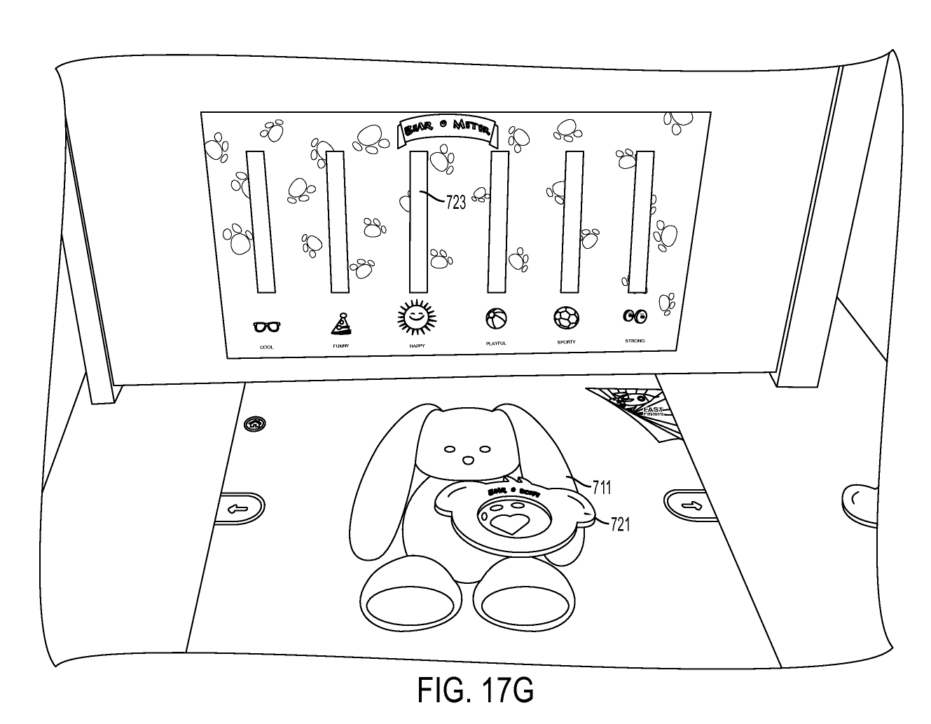

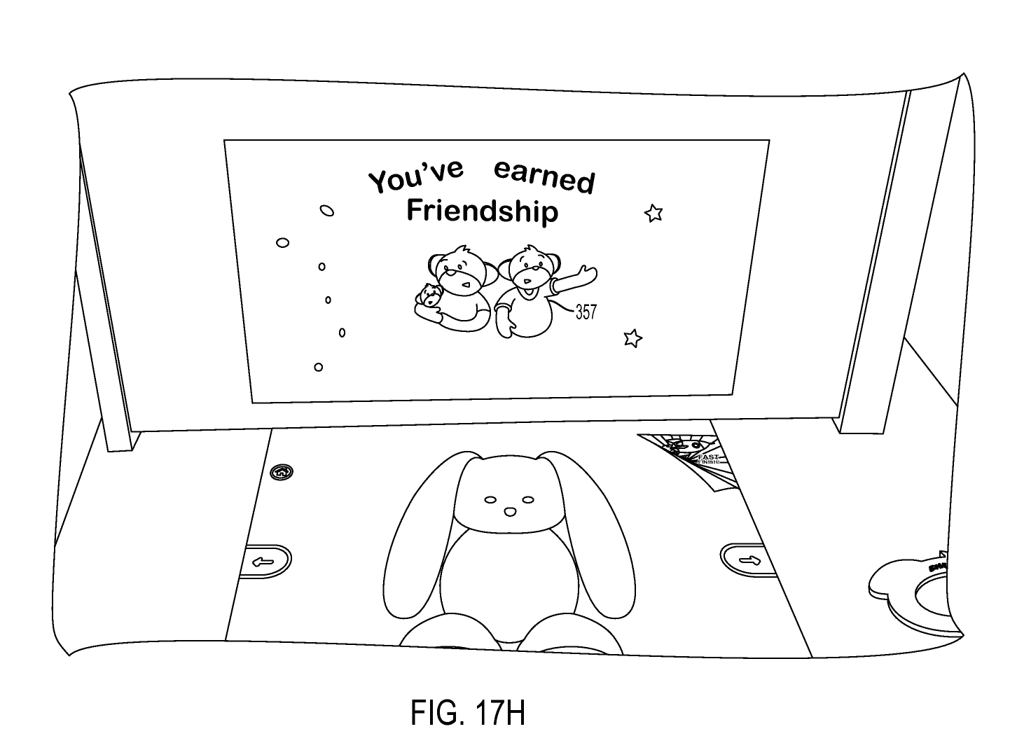

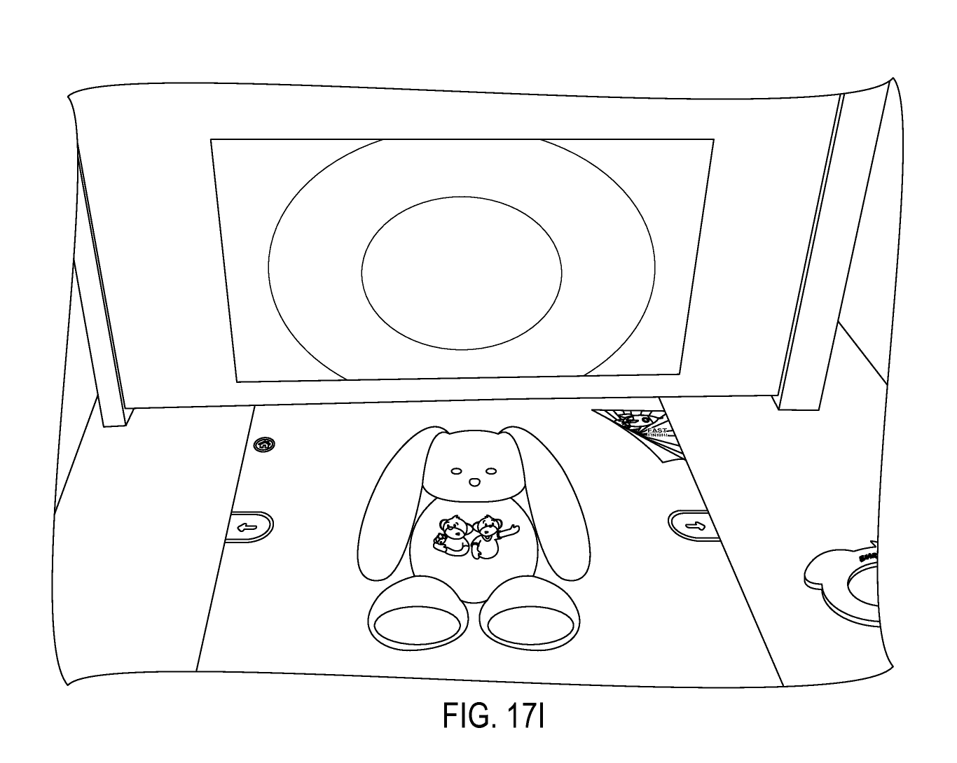

The indicia is read by a scanner (307) to load the specific toy (53) into the station network, create a blank profile for it, and begin attaching attributes thereto. Scanning is shown in FIG. 17A. The characteristic station (300) will generally be used to supply initial characteristics to the toy (53), and also to provide for initial identifying information for the user. This comports with the illusion of the user as the toy's (53) creator, and the toy (53) as a currently blank slate. As indicated above, the stations in the workshop (10) can utilize the profile to allow for identification and personalization, but can also serve as entry stations for populating the information in the profile. Thus, the stations generally utilize some information to personalize the experience, while also collecting additional information to enhance the profile and later interactions. In this first station, the hang tag (57) provides for initial identification of the toy (53) and association with a profile, and provides requests for more personalized characteristic information to assist in populating the profile.

In the depicted embodiment, characteristics for the toy (53) are embodied in the toy's (53) “heart” as part of the play experience. The “heart” of the toy (53) is generally a small heart-shaped plush (301) which is dispensed via tubes (303) to a user. The heart (301) is generally not an interactive device, but is purely a plush object which is a surrogate for the storage of characteristic information in the profile. However, in an alternative embodiment, the heart (301) may include a small computer processor or other digital component which will act as a unique identifier and transmitter for a signal which can be detected by the various stations. This would allow the toy (53) to communicate directly with the stations or other interactive systems.

In order to embody the toy (53) with identity and characteristics, the heart (301) is used as a symbolic storage unit which is “loaded” with material by the user. It may be an actual storage unit, but more often than not the heart is simply a surrogate and storage is performed by loading the information into the toy's (53) profile elsewhere on the station network via the computer at the characteristic station (300). Thus, while the information appears to the user to be loaded into the heart (301), the information is actually stored in the profile on the network.

FIGS. 12 and 13 provide for various screen shots which show how the digital display (305) can be used to provide for an interactive play environment in selecting characteristics. In this disclosure, the display (305) is intended to interact with the heart object (301). The heart (301) is not specifically designed for use with the station (300) and, as such, generally does not include machine readable indicia. Therefore, the heart (301) generally needs to be identified by the station (300) in a different manner.

In the embodiment of FIGS. 12A, 12B, and 13A-13F, the station (300) begins by requesting some basic information. Specifically, the toy (53) will generally be first identified to the station. This is usually performed by scanning a machine readable identifier associated with the toy (53) as contemplated above. A screen showing such an initial scan request is shown in FIG. 17A and such a cue to scan will generally be repeated at multiple stations. Once the toy (53) is scanned, a user's birthday is requested in FIG. 12A. In order to keep the process moving, FIG. 12B provides for a screen to reset the process if the user is not continuing to interact with it.

Once basic information is obtained, the user may be cued to take a heart (301) from the dispenser (303) and place it on the screen (305) as shown in FIG. 13A. FIG. 13B shows a user placing the heart (301) on the screen. As indicated, in one embodiment, the heart (301) includes no digital components or communication capability and to identify it, it is identified by it having a general volume and/or shape. Specifically, the heart (301) is identified simply as being roughly heart-shaped and within certain size parameters. A discussion of such identification methodology is provided in U.S. Provisional Patent Application Ser. No. 61/653,945 the entire disclosure of which is herein incorporated by reference. Alternatively, anything placed on the screen (305) could be identified as a heart (301) with the expectation that is all that is generally so placed. Still further, an image of the heart (301) could simply be on the screen (305) indicating for the user to place the heart there and the screen (305) could simply react in the same manner regardless of whether an object is placed or not.

Once the heart (301) is on the screen (305) or otherwise identified as being present, the screen (305) will indicate that the heart (301) is ready to be “loaded.” The loading operation will generally provide a specific number of attributes to the plush toy (53) which are symbolically stored in the heart.

In the first interest, the user's name is added as shown in FIG. 13C. In an embodiment, this name entry will be via a “keytar” which provides for a unique sound associated with the name as discussed below. The name can be entered via a keypad or virtual keypad (351) by simply typing letters as is understood by one of ordinary skill or can be spoken or entered in some other fashion. Once entered, the user's name is recorded as part of the digital profile for the toy (53).

The user's name will be used throughout the process to provide for a more personalized experience to the user. In particular, since the user's name is now associated with the profile, whenever the toy (53) is scanned at a later station, the station can display the user's name and welcome them. In an embodiment, the user's name may also be reproduced audibly. However, it is well understood that machine interpretation of language is often imperfect and therefore attempting to have a machine speak the name aloud could result in the name being mispronounced. The problem is exaggerated because certain names may be spelled the same but pronounced differently (for example the name “Elena” may begin with a hard or soft “e” sound).

In an embodiment, instead of speaking the name, the computer may associate a particular sound to each letter of the name, and the sounds can then be played whenever the name appears. This process is referred to as a “keytar” as the keyboard produces a single note for each keystroke (letter) in the same manner as plucking a particular note on a guitar or playing a key on a piano. This gives a particular sound association with the name without risking mispronunciation.

Once the user's name has been entered, the user can be cued to provide for specific characteristics they want the toy (53) to have. These can be standard human characteristics or things that may be specific to a toy (53). For example, in the screen shot of FIG. 13D, the characteristics include strength, athleticism, humor, and similar human characteristics. Special characteristics may also be applied for the particular user if they have characteristics that trigger such information. For example, if the user's birthday is within a day or two of the current date, a special characteristic to assign a birthday characteristic to the toy (53) could be provided. Similarly, if the user was identified as a prior purchaser of two or more of the same toy, a characteristic “twins” could be provided. Still further, in an embodiment, the user could be identified as a parent of a child with the same toy and this toy could automatically be loaded with identical characteristics as entered by the child on the first toy. This can allow the parent to create a duplicate toy which can literally use the same profile. Thus, if the first copy of the toy became damaged, the parent could cycle in a second copy which is both physically, and digitally, identical.

As shown in FIG. 13D, the characteristics are represented by icons (353) which the user can move on the touchscreen, as shown in FIG. 13E (with the “happiness” characteristic currently in motion), to place them “in” the heart (301). Characteristics so selected and moved to the heart (301) will be recorded to the toy (53)'s profile while those that are not will not be. The user can freely select characteristics and will then indicate when they are done (369). In FIG. 13F, the toy (53) has been provided with the characteristics of humor (361), strength (363), generosity (365), and athleticism (367).

In an embodiment, the toy (53) can also be named at the characteristic station (300). However, as the toy (53) is incomplete at this stage (it has not been stuffed or finished assembly), it is generally preferred that the toy's (53) name not yet be applied which is why the user's name was entered. Specific identity of the toy (53) by name can come later once the toy (53) is completed and the toy (53) is “born”.

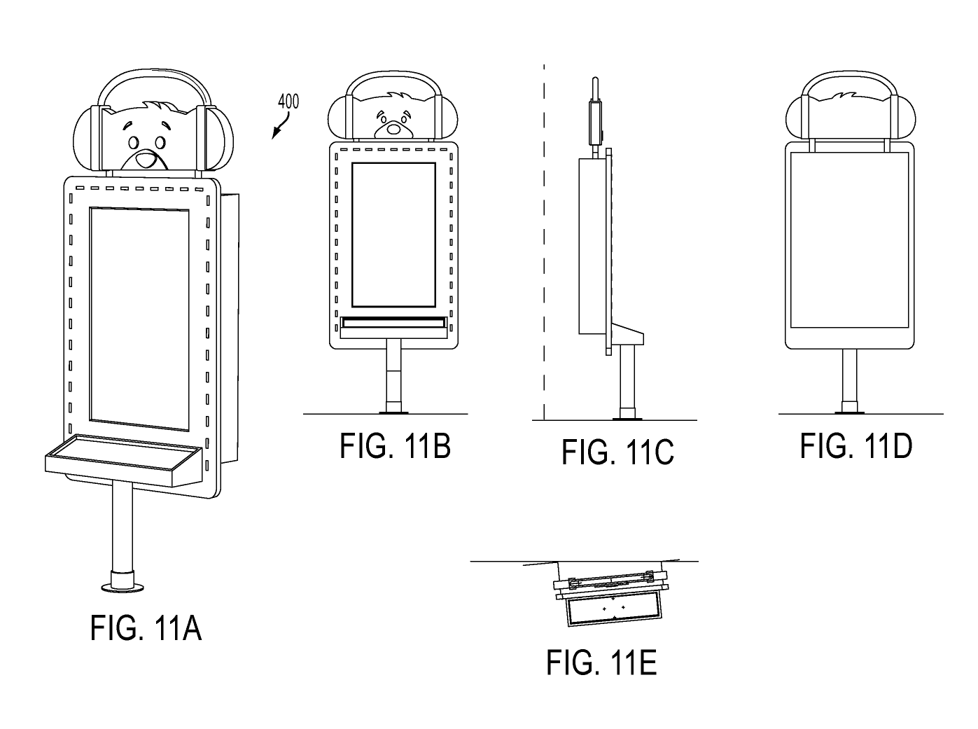

After the characteristics have been chosen, the user will generally move to a further station. In an embodiment, this may be a sound station (400) where a sound chip can be recorded to provide the toy (53) with audible feedback ability. An embodiment of a sound station (400) is provided in FIGS. 11A-11E and operation and design of an embodiment of such a sound station (400) is described in U.S. Utility patent application Ser. No. 13/467,812, the entire disclosure of which is herein incorporated by reference. For purposes of this disclosure, it should be recognized that when the toy (53) is scanned at the sound station (400), the toy (53) profile can be provided to the sound station (400). Thus, suggestions for sounds may be made based on the profile. For example, if the toy (53) has been indicated to be athletic, a sports-based sound may be suggested.

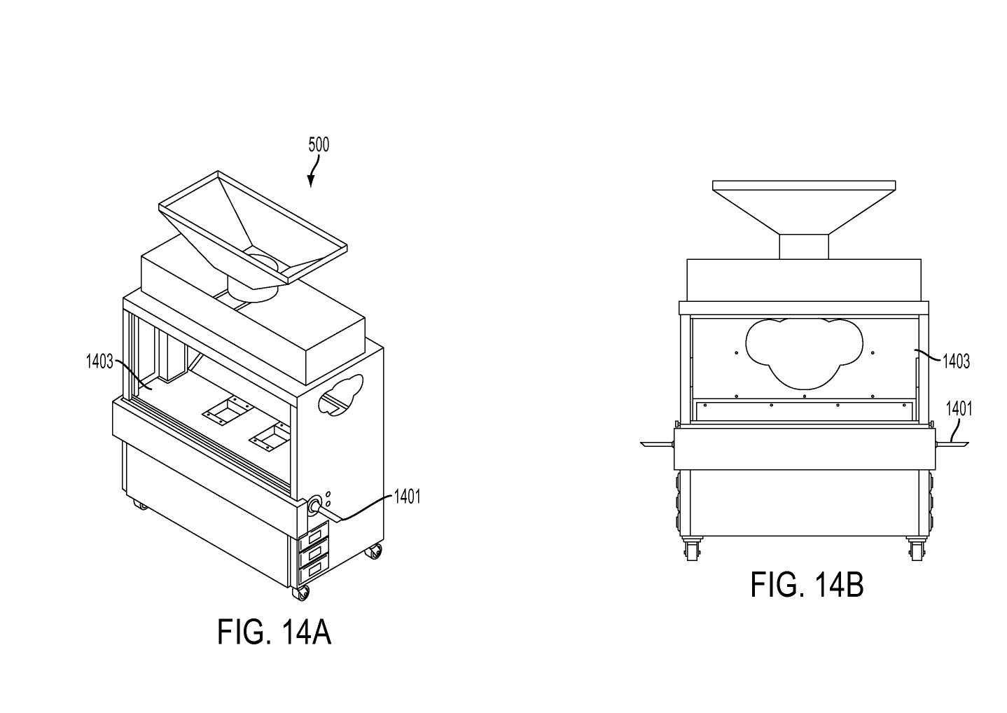

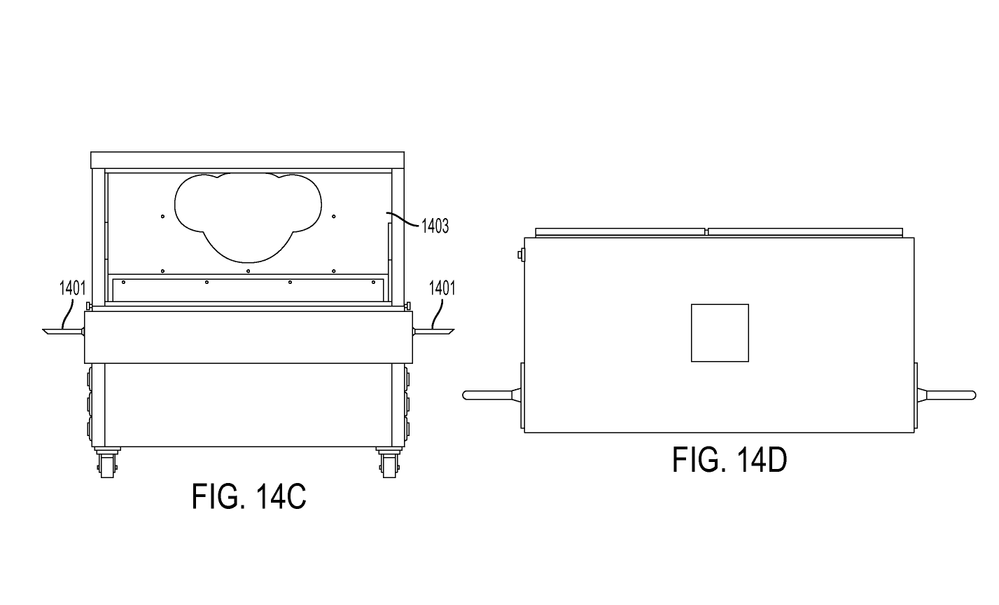

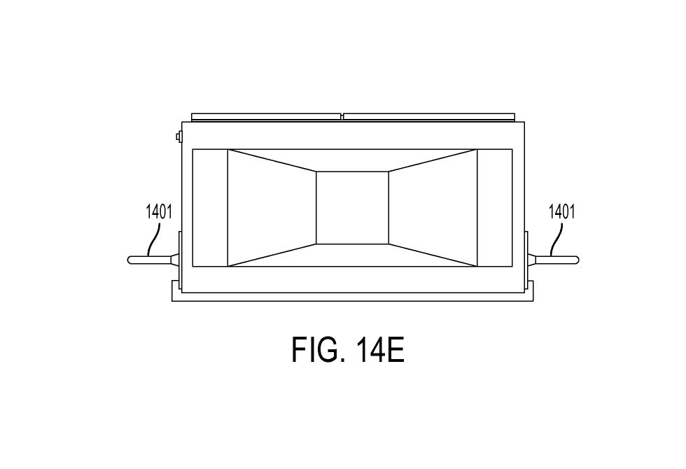

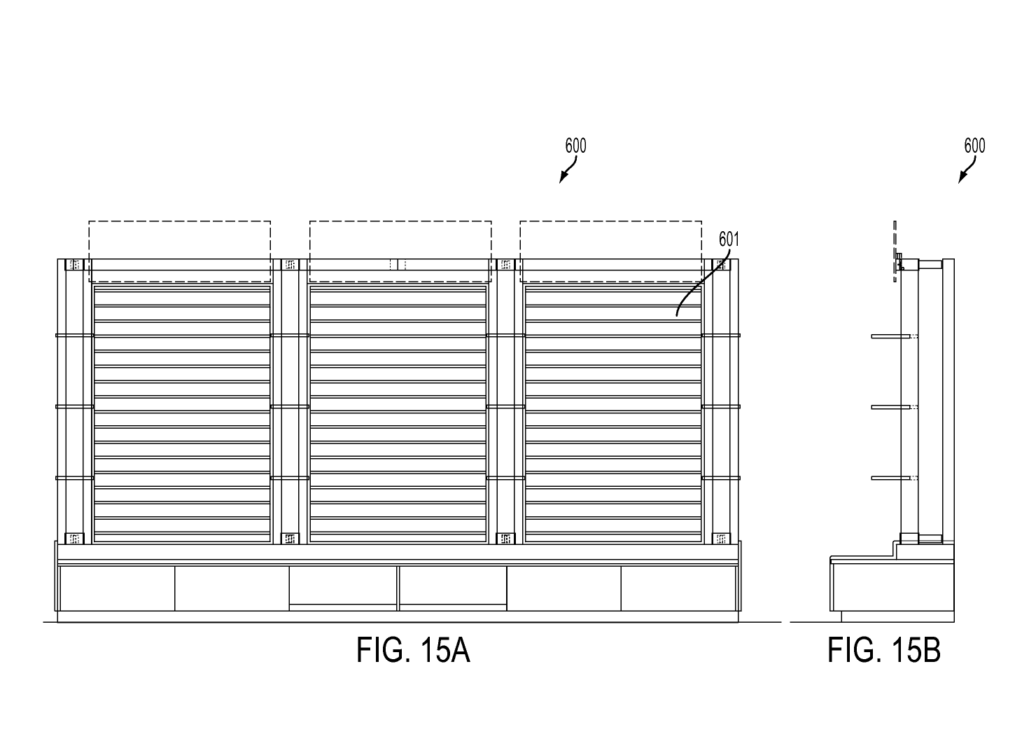

After sound recording is complete (or if it has been bypassed), the user will generally proceed to a stuffing station (500). The stuffing station (500) serves to stuff the toy (53), close it, and to now connect its component parts into a coherent whole. An embodiment of a stuffing station (500) is shown in FIGS. 14A-14E. Another embodiment is shown in U.S. Design Patent D427,209, the entire disclosure of which is herein incorporated by reference.

The stuffing station (500) may not be particularly interactive as it is generally operated by a professional operator and simply fills the role of filling the toy (53) with stuffing. However, as the stuffing station (500) can be interlinked to the network, an operator of the stuffing station (500) can provide feedback based on the profile of the toy (53). For example, the operator can be provided with a tablet computer, or similar device, or a display can be integrated into an embodiment of the stuffing station (500) for the operator's use. As in other stations, the tag on the toy (53) can be scanned and the profile loaded to be viewed by the operator.

The stuffing station (500) does serve as the point of connection where the heart may be placed inside the shell, the shell is filled with stuffing and the shell is sealed. Thus, the stuffing station (500) can be seen as connecting the characteristics the user applied to the heart, with the shell, and now the resultant toy (53). As such, the characteristics can again be used at the stuffing station (500). However, in the depicted embodiment, at the stuffing station (500), the profile is used by a human operator instead of by display on the stuffing station (500).

For example, the operator of the stuffing station (500) may receive the characteristics and be able to tell a user that may be a little nervous about the stuffing operation “hurting” the toy (53) that the toy (53) is “brave and will be OK” if the profile indicates bravery as a characteristic. This alternative operational mode where the profile is used by a human interacting with the user in the workshop (10), as opposed to machine interaction with the user, can be used elsewhere in the workshop (10) either in addition to, or instead of, the machine communication performed by the characteristic station (300) in this embodiment.

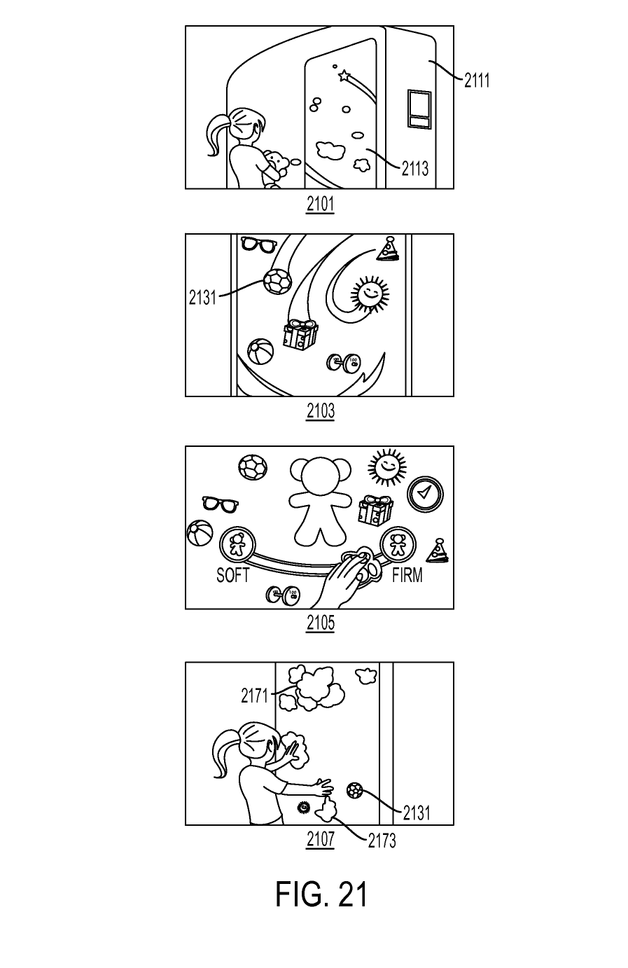

In addition to, or instead of, having the stuffing activity be controlled by an operator, FIG. 21 provides an embodiment of user interactive stuffing process. In this process a stuffing station (500) similar to that of FIGS. 14A-14E may be used or the stuffing station (500) may be simplified and hidden behind a housing (2111) as shown in board (2101). The housing also includes a touchscreen (2113) as contemplated in other stations. In this embodiment of a stuffing station, when the operator loads the heart, board (2103) takes effect loading the elements of the toy's (53) personality into the stuffing station (500). The characteristics chosen may, thus, appear in icon form (2131) on the screen (2113) along with an image of the heart as shown in board (2103). The user may then select the type of stuffing level in board (2015) based on what resultant feel they want for the toy (53). While this setup is being carried out, a machine operator will generally attach the toy (53) to a fill spigot (1401) and will generally place the heart in the toy (53) shell.

Once the toy (53) is attached, the stuffing station (500) can enter board (2107) where a screen with wads of stuffing (2171) and the characteristics (2131) are shown. The screen may then include a representation of a funnel (2173) and the user can “stuff” the virtual icons of the stuffing (2171) and characteristics (2131) into the funnel (2173). As they do so, the hopper (1403) which is full of stuffing may send actual stuffing down the spigot (1401) and into the toy (53). The send may be in response to the user's actions, or may be at a fixed rate regardless of what the user does. In this way, the user can “control” the stuffing process without having to interact with a complicated and specialized machine.

Once the toy (53) is stuffed it is effectively formed and complete and the heart is integrated into the toy (53). However, the play experience of the workshop (10) does not necessarily need to stop. In an embodiment, the toy (53) may be cleaned at a wash station (900) in order to both remove any stray exterior stuffing and to ritually cleanse the toy (53) prior to dressing and play. An embodiment of a wash station (900) which can be used in the present workshop (10) is shown and described in U.S. Provisional Patent Application Ser. No. 61/653,945, the entire disclosure of which is herein incorporated by reference. Again, as discussed above, scanning of the toy (53) at the wash station (900) can provide for the user to be specifically welcomed, and for the wash station (900) to provide for specific feedback based on the characteristics of the toy (53).

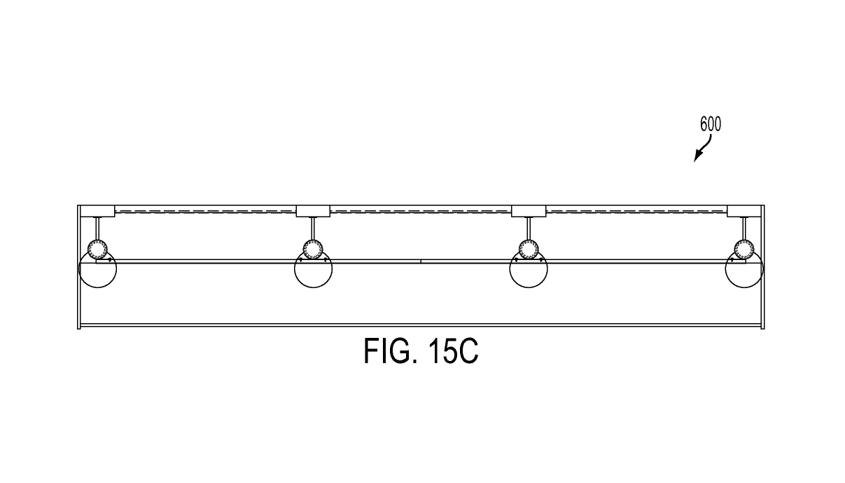

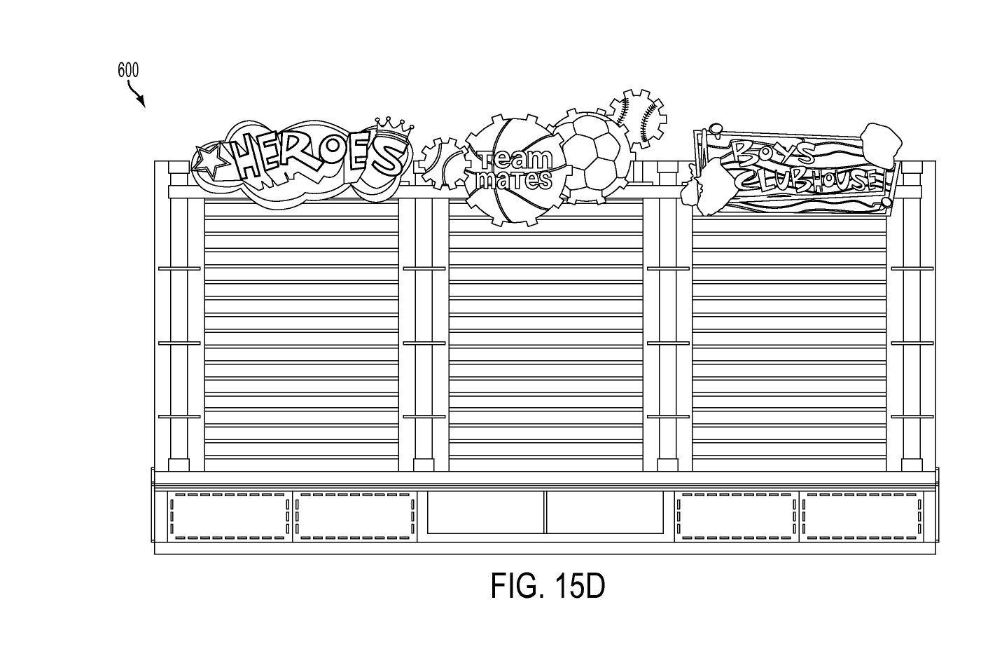

Once cleaned, the toy (53) can now be dressed. As mentioned earlier, as the process of toy (53) creation in many respects results in an anthropomorphic treatment of the toy (53), the toy (53) not being “naked” can be desired. A dressing station (600) is shown in FIGS. 15A-15D which provides for various racks (601) where clothes for the toy (53) can be displayed in the same fashion as human clothes at a store. In the depicted embodiment, they are arranged by type as shown in FIG. 15D. This allows for the user to pick out desired clothes by type and appearance. While the dressing station (600) of the depicted embodiment does not include an enhanced reality experience in this embodiment, in an alternative embodiment, an enhanced reality process to assist the user in locating coordinating outfits, or outfits fitting a particular criteria, can be present. An embodiment of such an enhanced dressing station is provided in U.S. Provisional Patent Application Ser. No. 61/697,530, the entire disclosure of which is herein incorporated by reference.

The dressing activity can be assisted through the use of an interactive dressing station or through the use of humans in the workshop. Again, identification of the user and toy (53) to an enhanced realty station or to a human worker allows for specific suggestions to be made and interaction to occur based on the profile. Thus, a toy (53) which is identified as being athletic, may have athletic clothing (such as a team jersey or swimsuit) suggested, while a toy (53) described as “cool” may have sunglasses suggested.

Once the toy (53) has been dressed, the toy (53) is essentially ready to be taken home and is complete. However, the workshop (10) experience is not necessarily over. Once the toy (53) leaves the workshop (10) it is likely that the identification hang tag (57) may be removed or damaged. Thus, in an embodiment, a setup station (700) is provided to allow for further refinement of the profile, addition to the profile of additional information such as, but not limited to, information which allows for the profile to be accessed without the hang tag (57), and for a creation of a toy (53) avatar and as an anthropomorphized object.

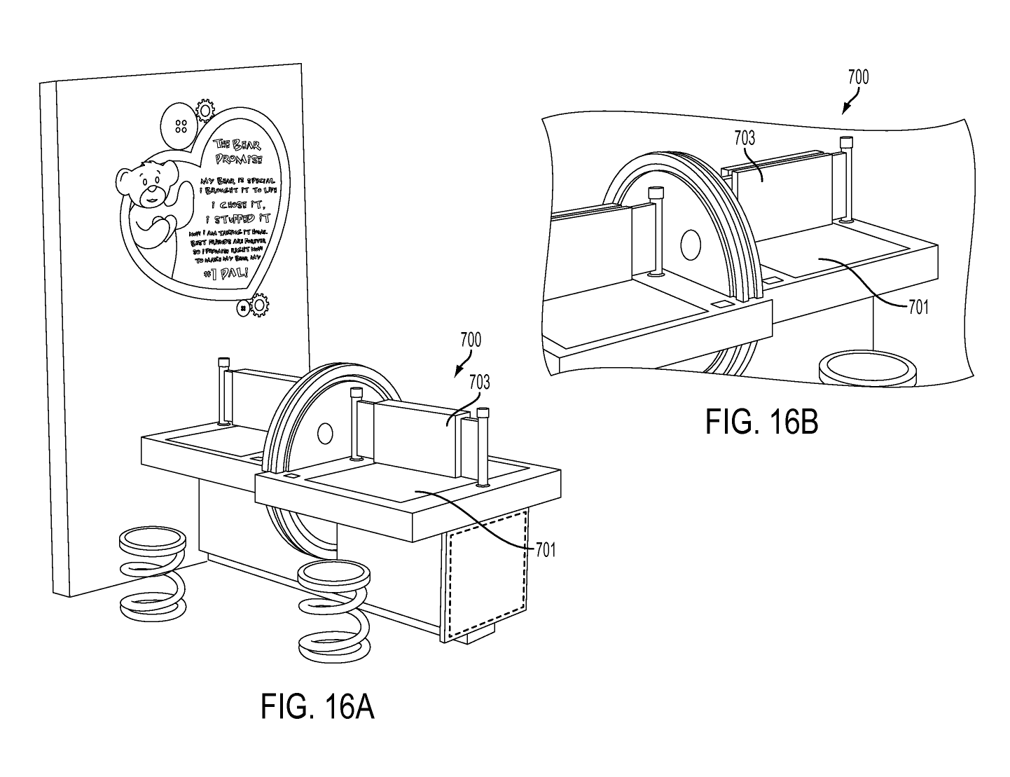

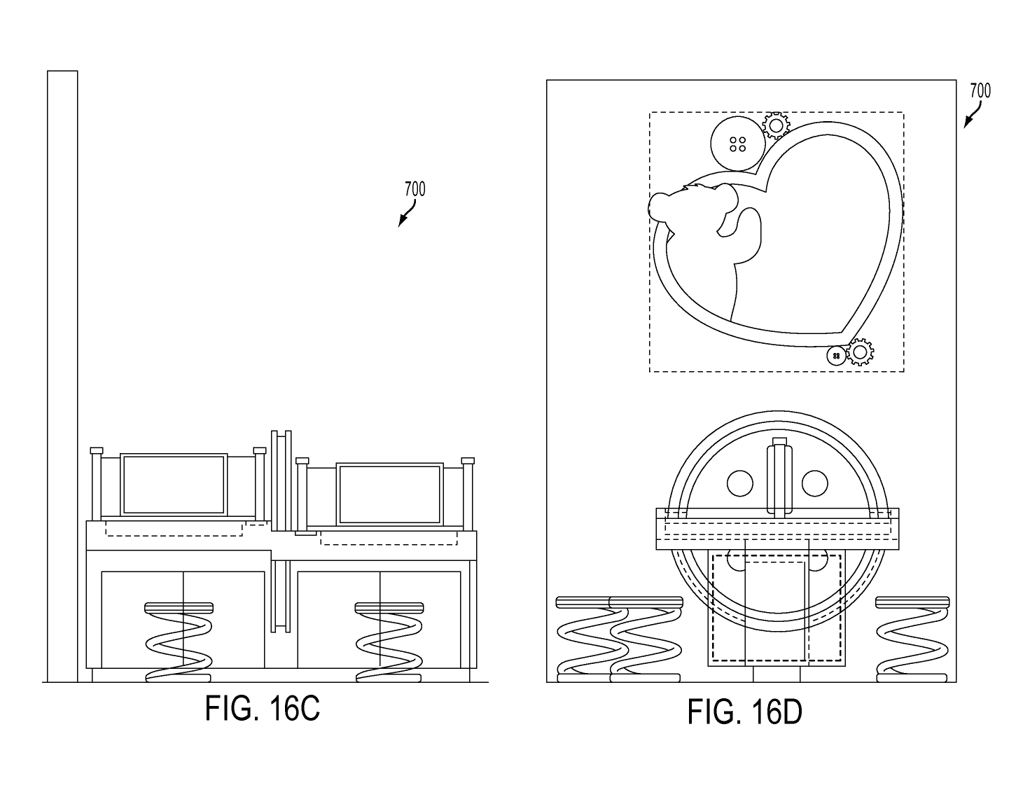

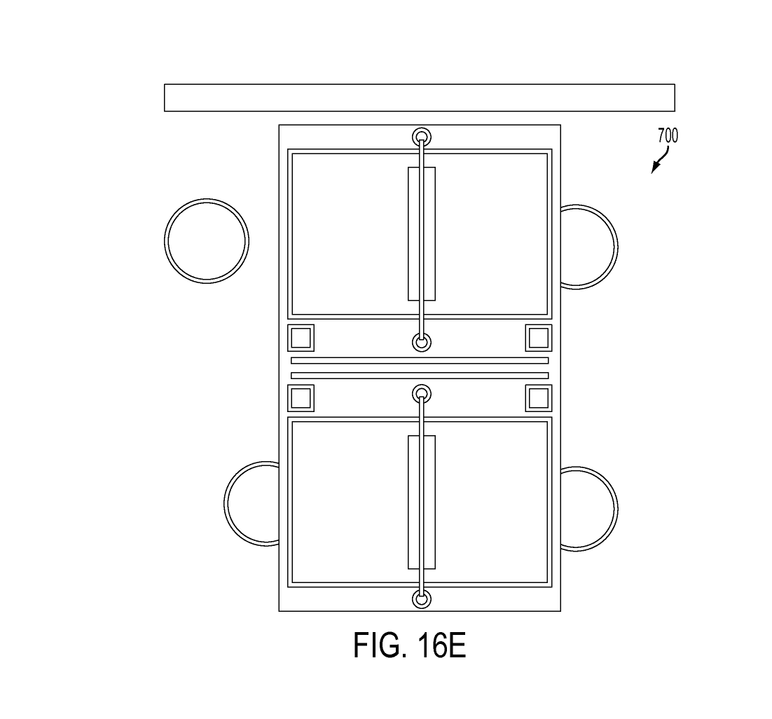

As discussed above, the toy (53), in an embodiment, does not yet have a name as prior interactive stations where the profile was modified (e.g. the characteristics station (300)) were positioned prior to the toy (53) being “complete”. Thus, this later station can be provided to allow the toy (53) to be named (identified) and become a complete object with all its attendant characteristics. FIGS. 16A-16E provide various views an embodiment of a setup station (700) that allows for the toy (53)'s electronic profile to be completed. As can be seen in FIGS. 16A-16E and 17A-17I, the setup station (700) utilizes two displays (701) and (703), although more or fewer can be used in different embodiments. Display (701) like display (305) is horizontally positioned to act as a surface, while display (703) is vertically positioned to provide instructions and additional information.

The toy (53) is generally identified to the setup station (700) as discussed for prior stations by scanning the hang tag (57) as indicated in FIG. 17A. As the toy (53) is now “complete,” the user is generally requested to have the toy (53) be analyzed by placing it as shown in FIG. 17B. When the toy (53) is placed on the display (701), the toy's (53) presence is detected and analyzed as discussed previously and the toy's (53) current profile is loaded. FIGS. 17C and 17D show two different toys (53) being analyzed. Note that the “analysis” can be purely play value as the profile can be loaded solely from the scanned hang tag (57).

Once the toy's (53) profile is loaded, a virtual avatar of the toy (711) is provided on the screen (701) and a power-up display (713) is shown on screen (703) on FIG. 17E. The user is now prompted to “activate” the toy's (53) characteristics by scanning the toy (53) to find the characteristics. This can be done through the use of a particular interactive device (721) which may be a fixed interactive device interacting with the screen (701) as those terms are used in U.S. Provisional Patent Application Ser. No. 61/653,945, the entire disclosure of which is herein incorporated by reference. In this case, the interactive device (721) acts like an X-ray machine showing the “interior” of the toy (53). It should be recognized that as this activity utilizes a completed toy (53), it's play value can also be provided to a user for use at their home and/or could be used on a toy (53) created at a prior time and brought to the workshop (10).

As the device is scanned over the avatar (711), the characteristic icons (353) are seen inside the avatar (711) and are activated on the power-up screen (713) as they are located. The icons (353) may be positioned in fixed positions, or may be randomized. In FIG. 17F, the happiness icon (371) is seen and the associated bar (723) is filled. As shown in FIG. 17G, a digital representation of the heart (301) (which is physically inside the toy (53)) can also be shown on the avatar (711).

Once all the characteristics have been “activated”, a special characteristic (in this case friendship (357)) can be created and moved to the avatar (711) as shown in FIG. 17H and 17I. This can effectively allow the toy (53) to be “born” as it is now complete and has had the profile characteristics, as chosen by the user, fully setup.

One can recognize that while there is significant play value to completing all the steps above, they are clearly not necessary to make the toy (53) as the characteristics are already present in the profile. As such, the setup station (700) can offer a bypass button (751) if the toy (53) is being created by a user that is not interested in the play experience, but simply wants the toy (53).

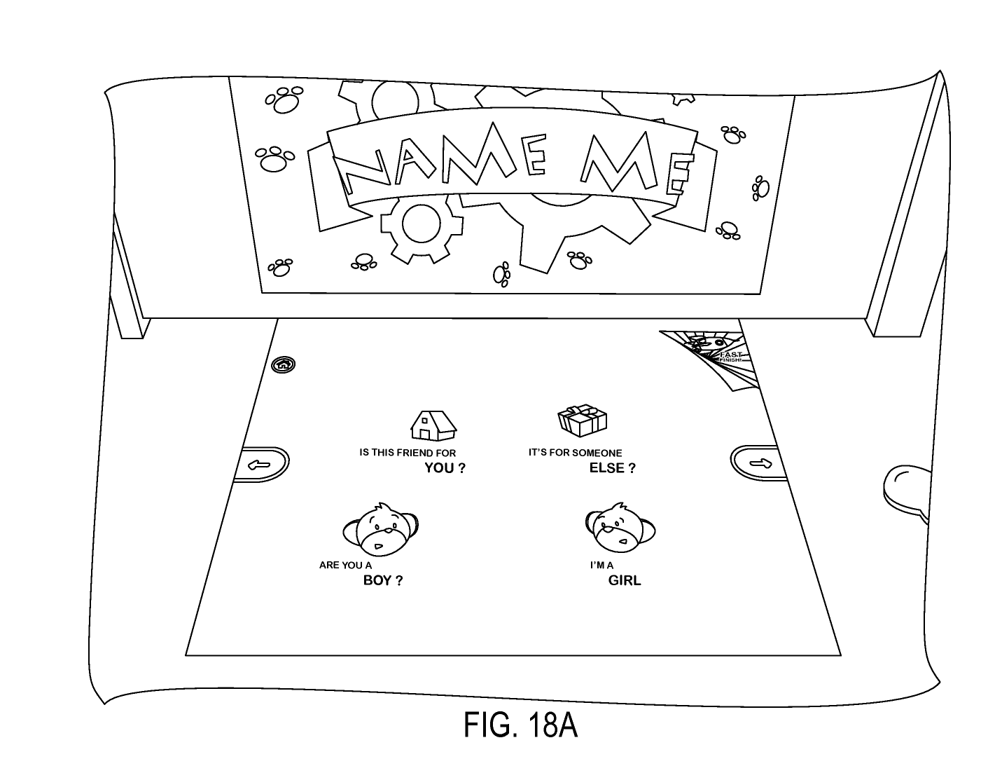

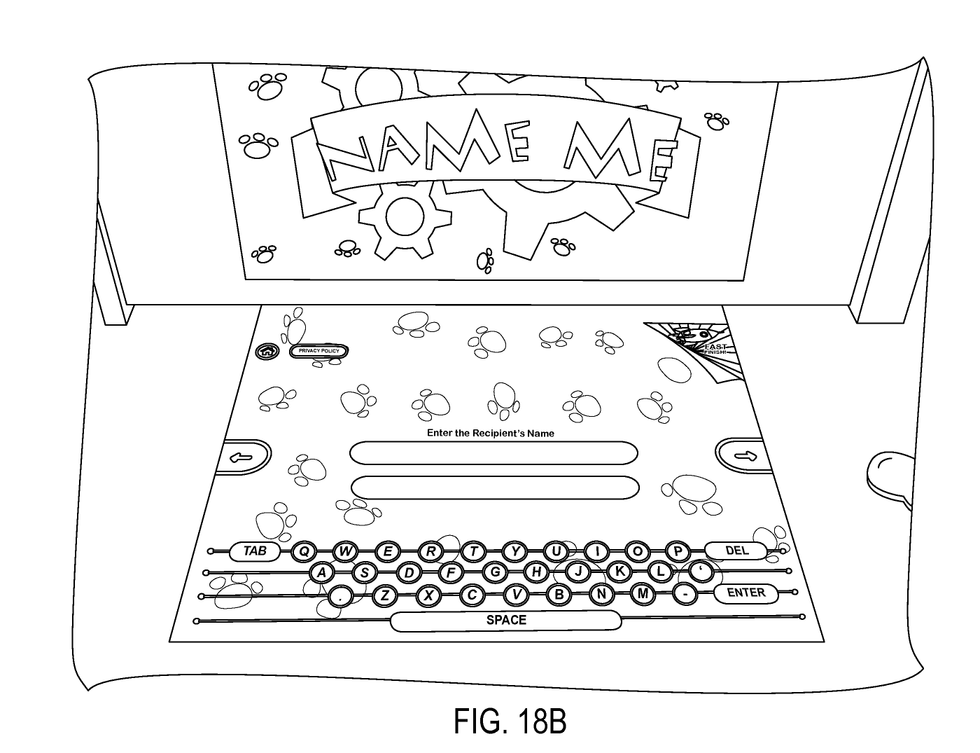

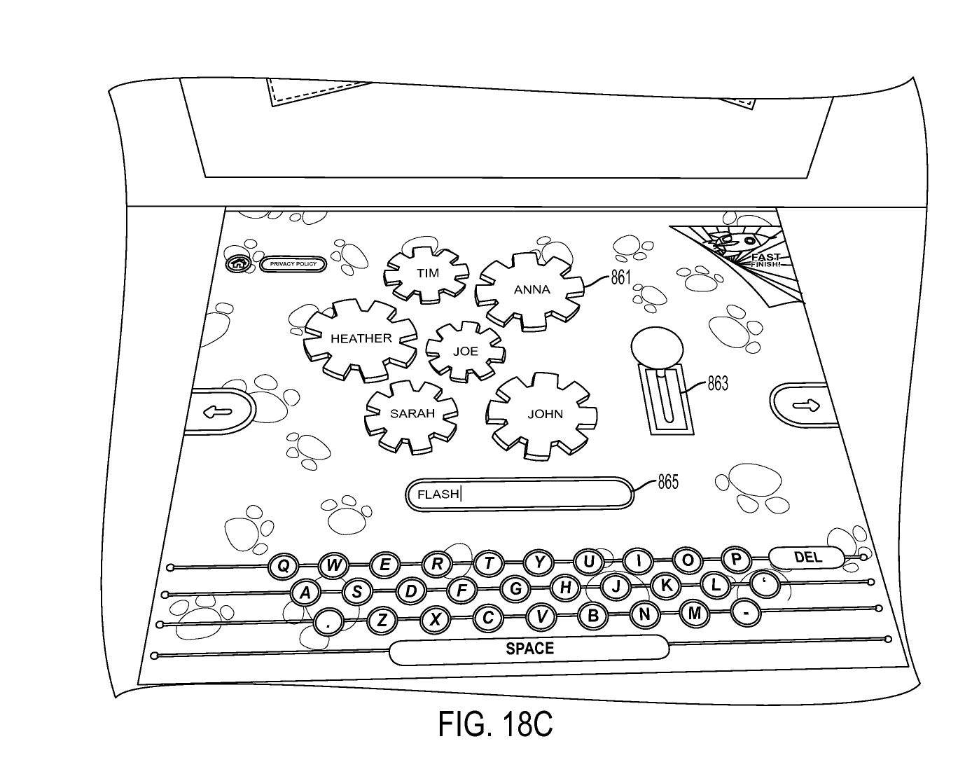

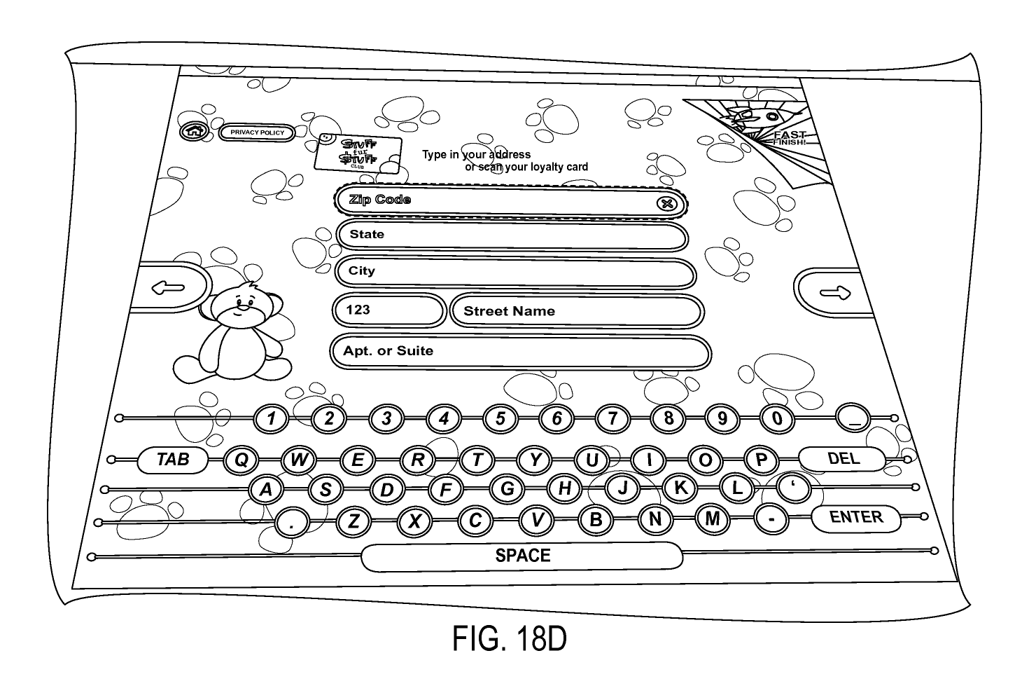

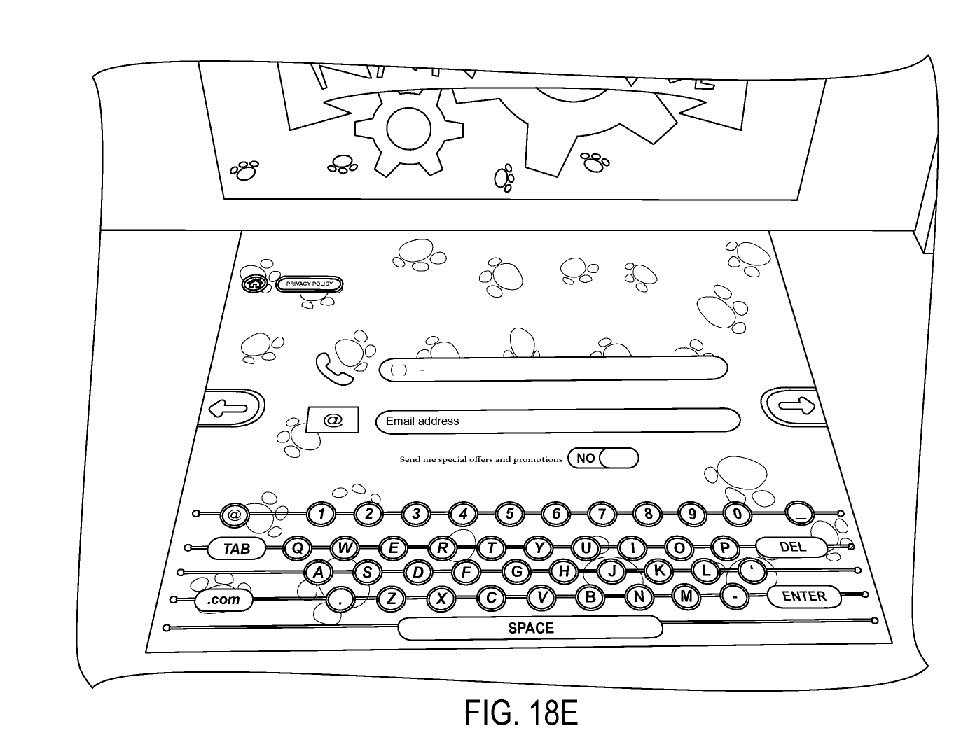

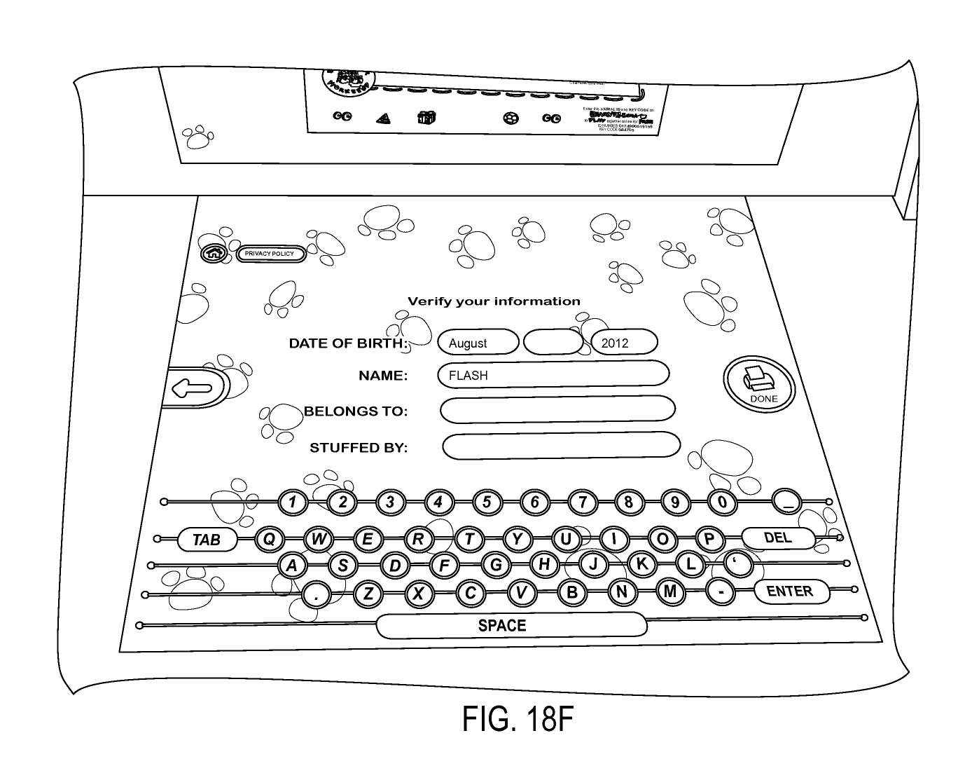

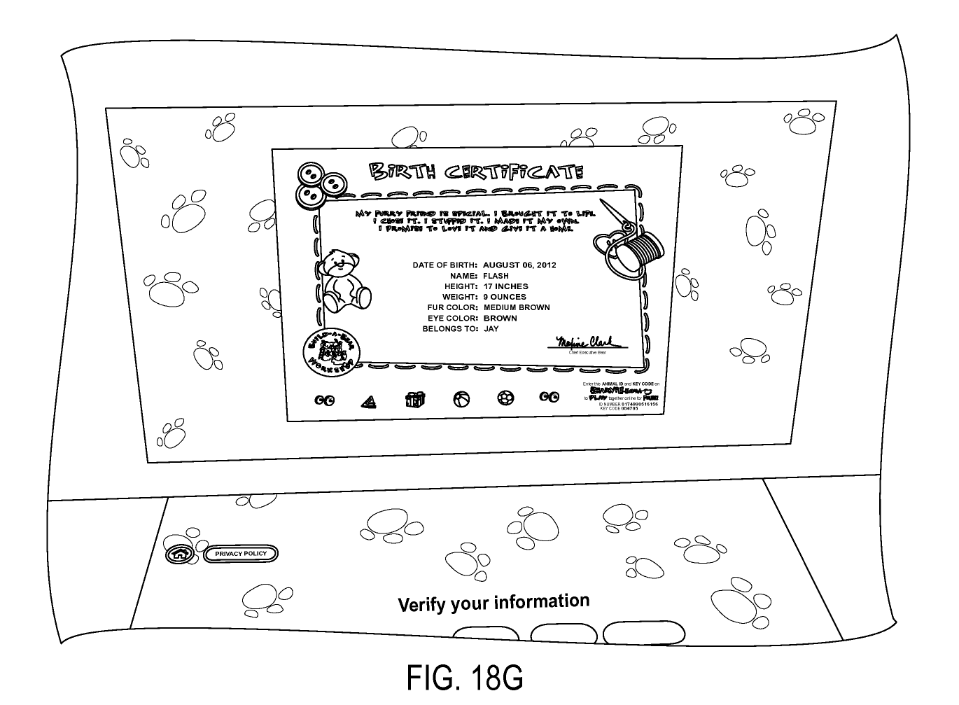

In FIG. 18A additional information is requested from the user to continue completing the profile of the toy (53). Specifically, the nature of the owner of the toy (53) (as opposed to the user as they may be different) is requested in FIG. 18A. Specifics of the owner can then be provided including the owner's full name in FIG. 18B, the owner's address in FIG. 18D and the owner's contact information in FIG. 18E.

As the toy (53) is effectively “born,” The user can now name the toy (53) by entering a name, or by choosing from a selection of names. This is shown in FIG. 18C with a selection of random names being chosen (861) with a generator (863) allowing more names to be provided. Alternatively, a user can enter a custom name (865).

The addition of this further information in the profile also allows for the toy (53) to be more permanently linked to the user and/or owner and to allow for additional information about the user and/or owner to be stored. In this way, gentle suggestion can allow for the toy's (53) profile to be retrieved even if the machine readable indicia on the hang tag (57) is no longer present. For example, if the user returned to the workshop (10) as discussed above, they can identify themselves to one of the stations (e.g. the interactive storefront (100)) via marketing content, a frequent buyer card, or by typing in identifying characteristics, and the station can then ask if they have this toy (53) from the profile with them.

If a particular toy (53) is indicated to be present, the station can respond discussing characteristics of the toy (53) from the profile. For example, if the user had created a toy (53) with athletic being a characteristic and had purchased a basketball jersey for them, the system (or a human employee) accessing the profile from the station network could inquire if the toy (53) had played in any recent basketball games. Further, if the user had utilized an online avatar of the toy (53) (discussed below) in a particular way, that could also be mentioned.

Still further, the information in the profile can be used to identify the owner of the toy (53) if it were to become lost. In the event that the specific toy (53) was identifiable (e.g. from an attached indicia or digital chip such as the sound chip), information about the toy's (53) owner could be obtained from the profile and the toy (53) could be returned.

The ability to identify the toy (53) can also be particularly valuable if the toy (53) is to be connected to an online environment and have a representative avatar in that online environment. For example, the Bearville.com™ website allows for a user's plush toys (53) to have avatars that interact with an online digital environment. If the user already has an account, the creation of the toy (53) can also allow for the avatar of the toy (53) for use in this environment to be created and stored with the particular user so they can utilize these online features. Use of these features can also further populate the profile with additional information.

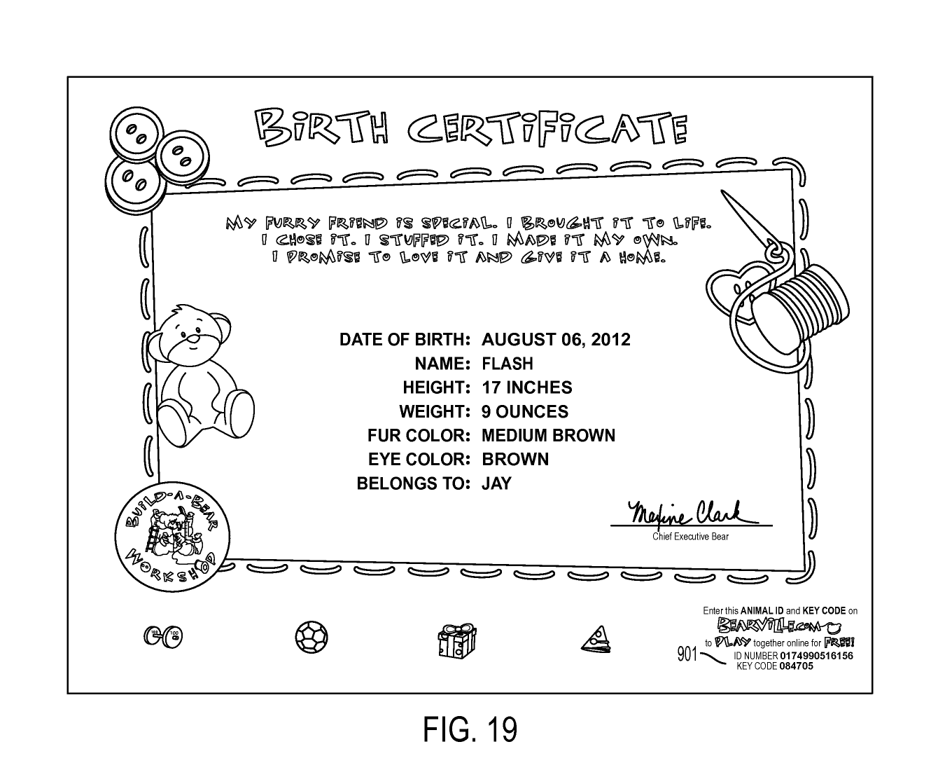

After the profile information has been completed, the information may be verified (as in FIG. 18F) and a “birth certificate” can be created for the toy (53). FIG. 18G shows the initial display of such a certificate to allow for information verification while FIG. 19 actually shows an embodiment of a certificate. The certificate may include a unique identifier (901) which may link to the profile of the toy (53) and may be useable to access an avatar for the toy (53) in an online environment.

It is important to recognize that while the above disclosure has discussed a variety of stations interacting with the user in a variety of ways and at specific times, stations may be interlinked and interactivity may be extended beyond the stations. For example, in an embodiment, the presence of a user having a birthday at any station, could cause all digital screens in the workshop (10) to show celebratory imagery. Still further, each station or other computer accessing the station network could perform the functions of any other station, or interact in the fashion of any other station. For example, a characteristic station (300) could utilize a human operator in the fashion of the stuffing station (500) discussed above or a selection station (200) could provide an enhanced reality profile entering experience as discussed in conjunction with the setup station (700).

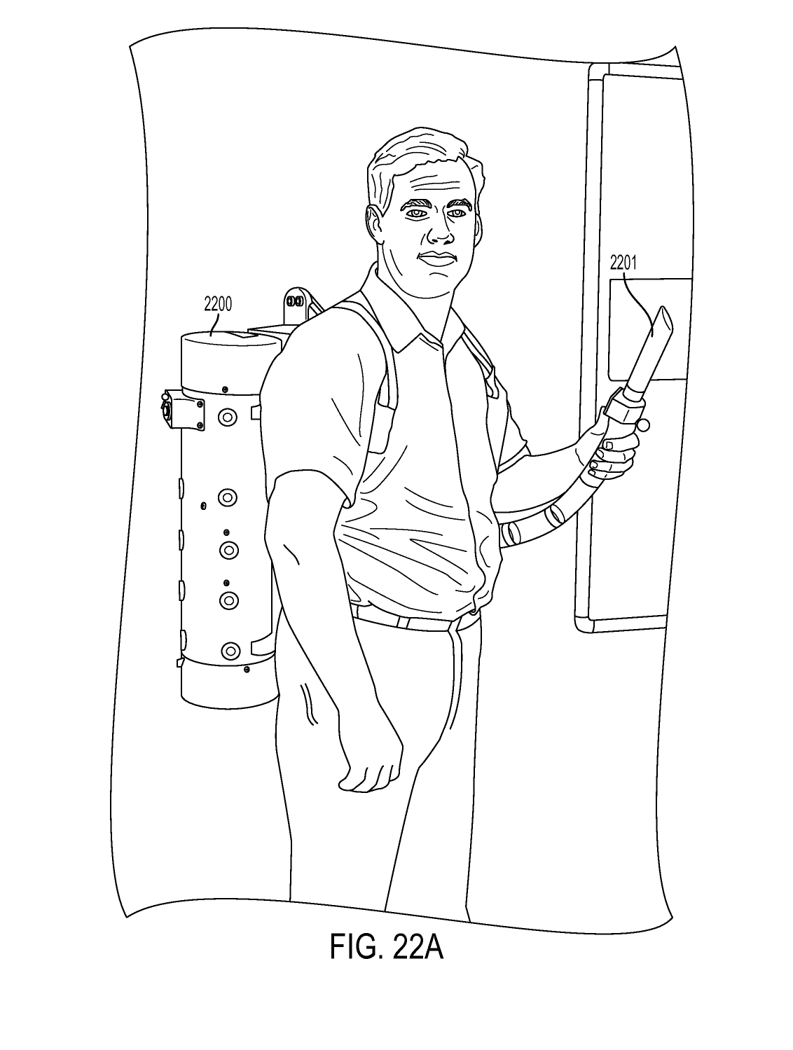

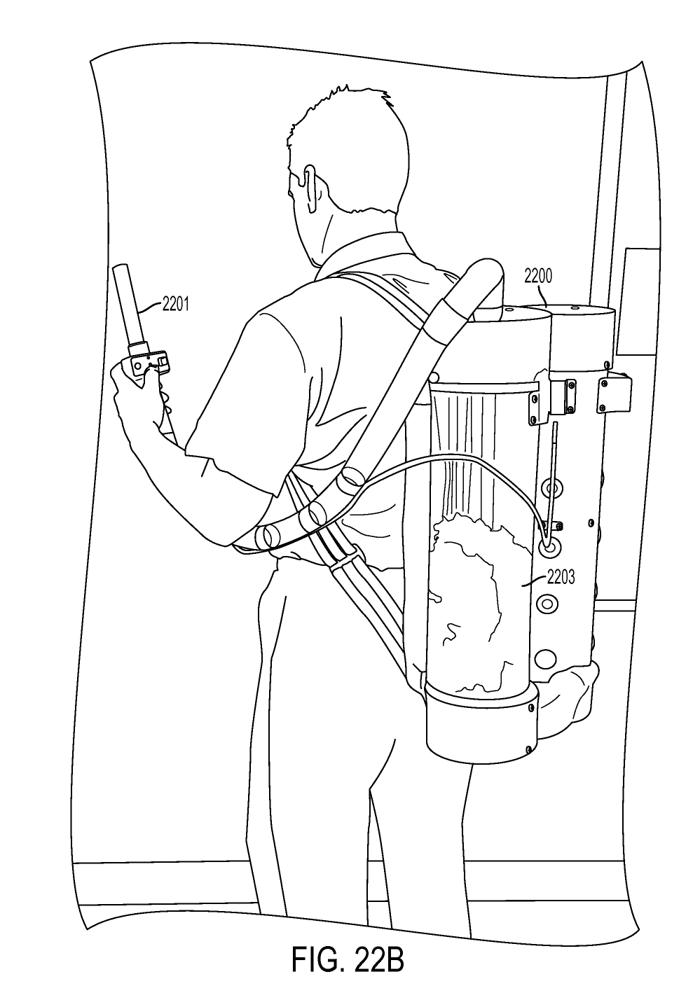

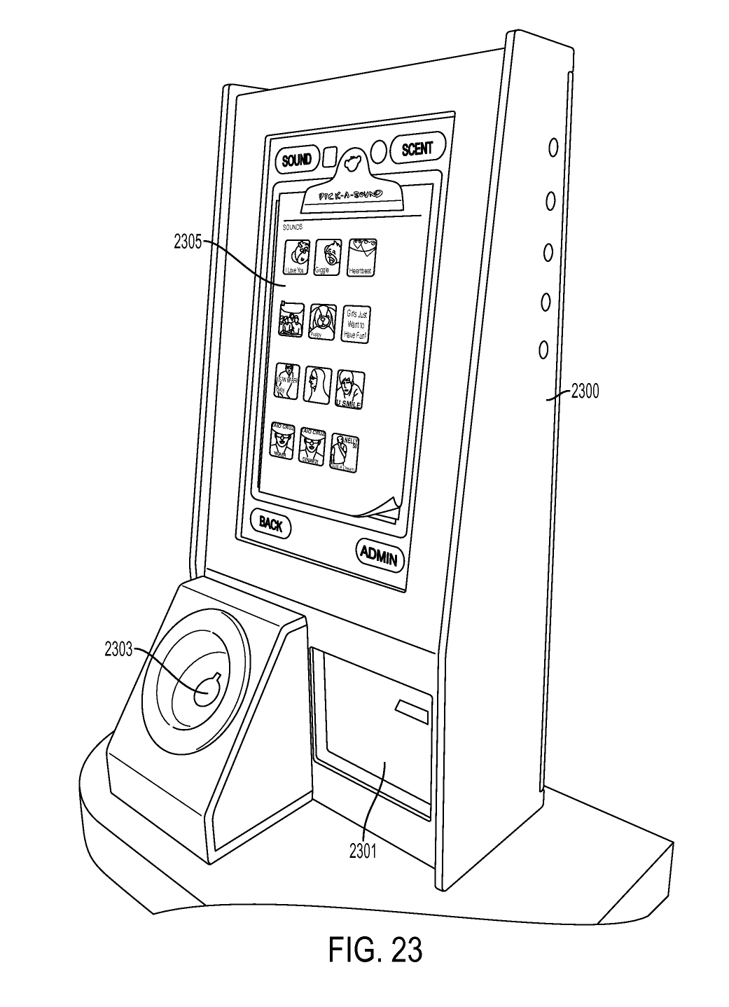

In an embodiment, it is also possible that some or all of the stations could be made portable. In this embodiment, the functional aspect of the station could be replicated as part of a backpack, briefcase, wheeled cart (dolly), tabletop, or any other generally man portable device. For example, FIGS. 22A and 22B provide an example of a backpack mounted stuffing station (2200) and FIG. 23 provides an embodiment of a tabletop mounted sound station (2300). The backpack mounted stuffing station (2200) includes similar components to the stuffing station (1400) in that it includes a stuffing hopper (2203) and spigot (2201). It also includes functional components such as a motor for fluffing the stuffing in the hopper (2203) and directing it down the spigot (2201) and into a toy (53). However, the backpack mounted stuffing station (2200) is generally quite a bit smaller and can be carried on the back of an average adult. Similarly, the tabletop sound station (2300) includes a sound chip hopper (2301), a loading cradle (2303), and a sound selection touchscreen (2305). The tabletop sound station (2300), however, is small and readily man-portable and can be placed on any available flat surface or even held in the hand or on the lap.

In the workshop (10), portable stations such as this stuffing station (2200) and sound station (2300) can be used in a variety of fashions. For one, the portable stations can allow for store personnel to go out to other stations and add the additional functionality of the portable stations to the workshop (10). This can help with better crowd control in the event that there are lines forming at various of the stations or if there are a particularly large number of patrons in the store, or even overflowing the store. Further, portable stations can allow workshop personnel to bring a station to a person who may be mobility impaired or otherwise unable to access a particular station in its standard format. For example, if they were not able to see a horizontally mounted display a portable version of the same station could be brought to them and positioned so they could see a similar display which is part of the portable station.

In a still further embodiment, portable stations allow for the workshop (10) to be entirely transportable. Specifically, the entire functionality of the workshop (10) as embodied in the portable stations, can now be taken to a remote location and provide a similar play experience to the one in the workshop (10). It should be recognized that in order to provide the digital components of the workshop (10) in portable form, personnel of the workshop (10) could use handheld computing devices (such as Smartphones or tablet computers utilizing wireless communications as would be understood by one of ordinary skill in the art) to scan or identify toys (53) and provide feedback based on them to the users if the user is waiting in line, or otherwise not interacting with any particular station.

Such wireless devices can connect into the station network to work in the same manner as any other device in the station network. The digital interactivity can be in conjunction with the portable station, for example store personnel utilizing the portable stuffing station (2200) could also have a tablet computer, or the tablet computer could be built into the portable stuffing station (2200) to provide similar or identical interaction to the stuffing station (500).

In a still further embodiment, certain station functionality may be provided on a user device. For example, a user who brings a tablet computer, Smartphone, or similar device with them to the workshop (10) may be able to download the functionality of any of the stations and perform any or all the station activities on their device instead of walking through the workshop (10) stations. Station functionality can also be augmented by a mobile device app. For example, a user may be able to utilize their device to record their voice, and then “upload” this to a sound station. In such a scenario, the sound may be recorded remotely from the workshop (10). For example, a parent that is currently deployed with the military could record a message using their device, and then send it to the workshop (10) or to their child. The sound can then be obtained by the sound station via the station network (either from the station network's internal memory or from a user device which has connected to the station network) and make that an optional sound to be added to the toy (53).

In order to determine that a mobile device in the workshop (10) is intending to interact with the workshop (10), there can be provided network authentication protocols. In an embodiment, these may be standard protocols for a public wireless (Wi-Fi) network as is understood by one of ordinary skill in the art. Once the mobile device is attached to the workshop's (10) network, it can be treated like a specialized station on the network specific to that user. The user profile could be stored or copied onto the device (so the user could access it outside the workshop (10)) and the device can be used to upload various items to the station network. This can include specific promotions or unlock codes as discussed previously.

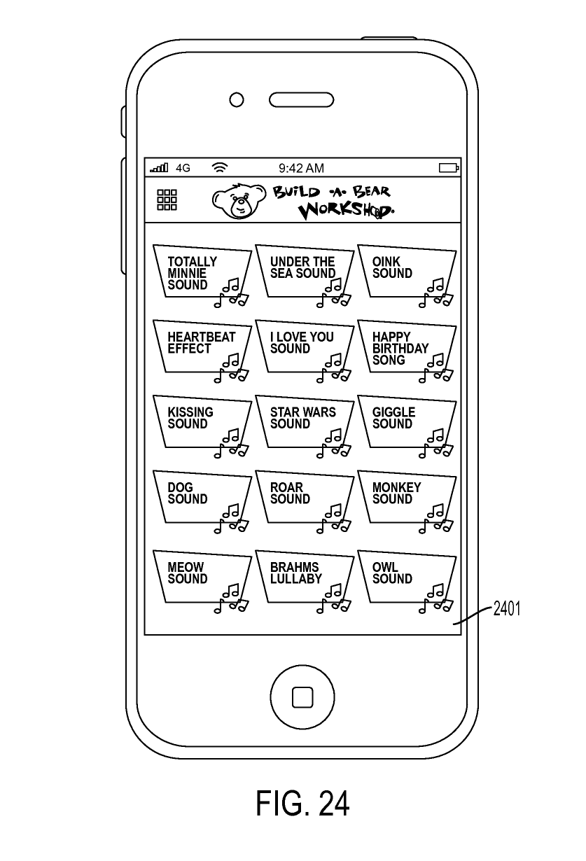

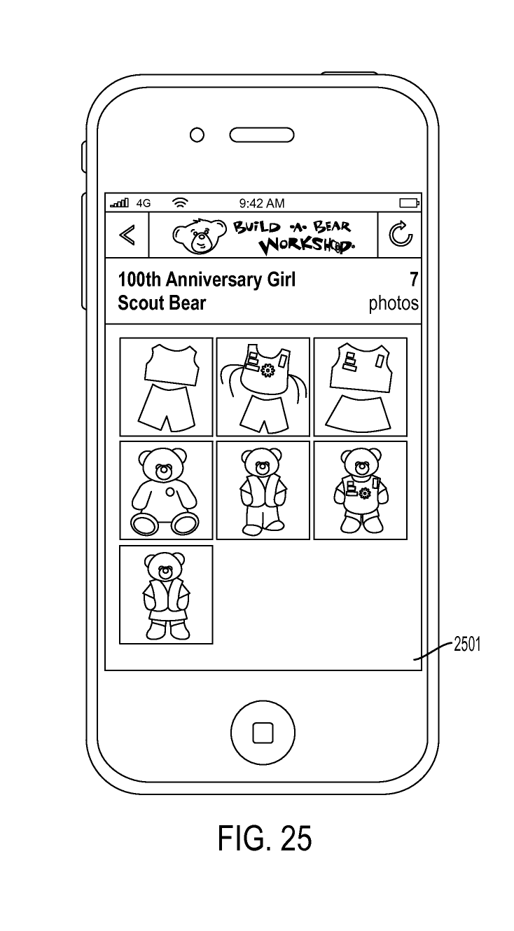

Similarly to providing functionality to the workshop (10), station functionality on a remote device could provide the functionality of various stations at home. For example, a home user could download a software version of the characteristic station (300) where they could scan the toy (53) at home (or otherwise enter an identifier for it into a home computing device). They could then modify its characteristics with their home computing device providing an update to the profile via the Internet or a similar network. Alternatively, they could utilize an e-commerce site to purchase the toy (53) with their computer or mobile device providing an appearance of the various stations in a virtual form. They can therefore create the toy (53) in the same manner they would in the workshop (10), but without leaving their home. FIGS. 24 and 25 show embodiments of home use sound station (2401) where a user can select sounds for a remotely purchased toy (53) to be placed on a chip to be installed in the toy (53) and a home use dressing station (2501) which can provide for an outfit for a remotely purchased toy (53). It should be recognized that while these remote stations (2401) and (2501) are intended for home use directly by a toy (53) purchaser. They could also be provided to store personnel for use as portable stations as discussed above.

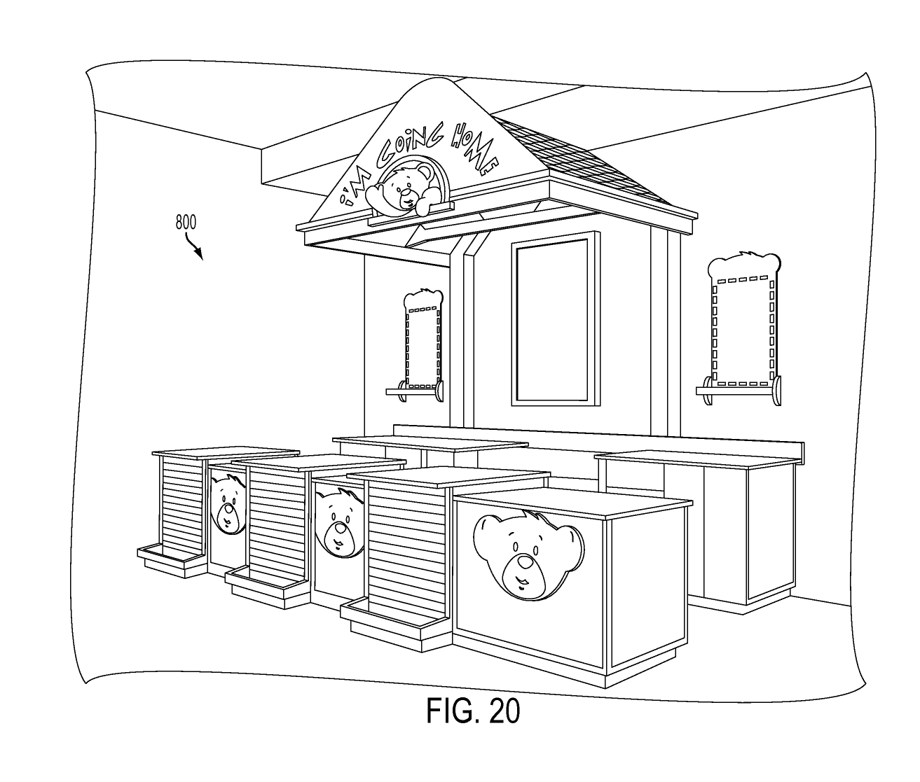

In the depicted store of FIGS. 1-5, the final station a user will generally utilize is the checkout station (800). This station is shown in detail in FIG. 20 and is generally designed to provide for purchase of the toy (53) and it being sent home. As with all prior stations, loading of the profile of the toy (53) will allow for personnel to interact with the user utilizing the profile of the toy (53). Further as the checkout station (800) can include a screen (801), the screen can show customized messages based on the profile of the toy (53).

It should be recognized that, while the disclosure above is focused on the various stations interacting with non-digital toys (53), or toys (53) that do not include digitally interactive components that can communicate the profile with the station network, the stations can, in an embodiment, also interact with digital toys (53) which are capable of more advanced communication. For example, the stations may be able to retrieve information from the toy (53) directly instead of or in addition to from other networked or otherwise paired devices and stations on the station network to provide for sharing of information from the stations and toy (53) in an interactive play environment. This can allow for the toy (53) to be identified even more uniquely once created and can eliminate the need to cue the user for information (e.g. the toy (53) may not need to be scanned to be identified).

The stations may also or alternatively be able to receive information from a user device, such as, but not limited to, a Smartphone (e.g., via a Bluetooth or cellular connection) or a tablet computer (e.g., connecting to the station network via the Internet). For example, if the toy (53) has a name which has been entered into a networked digital device (e.g. a user's phone) or into a computer processor in the toy (53) itself, the station may be able to refer to the toy (53) by name without need of access the profile on the station network. Similarly, a parent may be able to remotely (and discreetly) control a station from their smartphone to allow the station to react to a child without the child being aware that information was provided. This provides a further level of interactivity if the toys (53) or other devices brought to the workshop are capable of such enhanced interaction.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A method for associating characteristics to a non-digital device, the method comprising:
providing a non-digital device, said non-digital device being uniquely identifiable via an indicia attached to the device;
at a first station:
creating a digital profile for said non-digital device;
associating said digital profile with said indicia; and
populating said digital profile with characteristics;
at a second station:
obtaining said characteristics via said indicia; and
displaying said characteristics as being from said non-digital device.

2. The method of claim 1 wherein said non-digital device comprises a toy.

3. The method of claim 2 wherein said toy is a plush toy.

4. The method of claim 3 wherein said indicia comprises a machine readable code on a removable tag attached to said plush toy.

5. The method of claim 3 wherein said characteristics are personality traits for said plush toy.

6. The method of claim 3 wherein said second station comprises a station for physically assembling said plush toy.

7. A workshop for assembling a toy, the workshop comprising:
A station network interconnecting
a selection station;
a characteristic station;
a stuffing station; and
a checkout station;
wherein a toy is selected at said selection station;
wherein characteristics are assigned to said toy at said characteristic station, said characteristics being stored as a profile in said station network; and
wherein said stuffing station and said checkout station access said profile to display said characteristics of said toy.

8. The workshop of claim 7 further comprising an interactive storefront.

9. The workshop of claim 8 wherein said interactive storefront includes a game.

10. The workshop of claim 7 wherein a machine readable indicia attached to said toy is read at each of said stations to access said profile.

11. The workshop of claim 7 further comprising a sound station.

12. The workshop of claim 11 wherein said sound station also accesses said profile to display said characteristics of said toy.

13. The workshop of claim 7 further comprising a dressing station.

14. The workshop of claim 13 wherein said dressing station also accesses said profile to display said characteristics of said toy.

15. The workshop of claim 7 further comprising a setup station.

16. The workshop of claim 15 wherein said setup station also accesses said profile to display said characteristics of said toy.

17. The workshop of claim 16 wherein said setup station connects said profile to identifying information of an owner of said toy.

18. The workshop of claim 7 further comprising a washing station.

19. The workshop of claim 18 wherein said washing station also accesses said profile to display said characteristics of said toy.
